(19) United States
(12) Patent Application Publication
(10) Pub. No.: US 2026/0185882 A1
(43) Pub. Date: Jul. 2, 2026

(54) 6-AXIS FORCE TORQUE SENSOR BASED ON PHOTOCOUPLER AND METHOD OF SENSING 6-AXIS FORCE TORQUE BASED ON PHOTOCOUPLER MEASUREMENT

(71) Applicant: KOREA ADVANCED INSTITUTE OF SCIENCE AND TECHNOLOGY, Daejeon (KR)

(72) Inventors: HyunBin KIM, Daejeon (KR); KyungSoo KIM, Daejeon (KR); KeunHa CHOI, Daejeon (KR)

(73) Assignee: KOREA ADVANCED INSTITUTE OF SCIENCE AND TECHNOLOGY, Daejeon (KR)

(21) Appl. No.: 19/414,543

(22) Filed: Dec. 10, 2025

(30) Foreign Application Priority Data
Jan. 2, 2025 (KR) 10-2025-0000095

(51) Int. Cl. G01L 1/04; G01S 7/481; G01S 17/00

(52) U.S. Cl. CPC G01L 1/04; G01S 7/4815; G01S 7/4816; G01S 17/003

(57) ABSTRACT

The present disclosure relates to a 6-axis force-torque sensing apparatus that measures the magnitude and direction of an external force using a photocoupler, and includes a spring structure that includes a vertical displacement portion and a horizontal displacement portion and elastically deforms by an external force; a sensing substrate that includes a vertical displacement photocoupler that senses a vertical displacement of the vertical displacement portion and a horizontal displacement photocoupler that senses a horizontal displacement of the horizontal displacement portion; and a sensing substrate support that forms a predetermined gap between the spring structure and the sensing substrate.

### CROSS-REFERENCE TO RELATED APPLICATION

This application claims the benefit of and priority to Korean Patent Application No. 10-2025-0000095, filed on Jan. 2, 2025. The entire disclosure of the aforementioned application is incorporated herein by reference in their entirety.

### TECHNICAL FIELD

The present disclosure relates to a 6-axis force-torque sensing apparatus and a 6-axis force-torque sensing method, and more particularly, to a photocoupler-based 6-axis force-torque sensing apparatus and a 6-axis force-torque sensing method for measuring a magnitude and direction of an external force using a photocoupler.

### BACKGROUND

Force torque measurement technology has been continuously discussed and developed as more sophisticated control is required in the field of robot control.

In a conventional force-torque sensor, there is a method of measuring the magnitude and direction of an external force by detecting deformation using 12 or more strain gauges. This method allows for precise force-torque measurement, but it is expensive and difficult to miniaturize due to the large number of installed sensors, and in the case of miniaturization, a separate external signal processing device was required. In addition, since the strain gauge sensor is attached to a spring structure with silicone, the adhesion of the silicone weakens as impact accumulates, increasing the likelihood of sensor detachment. The silicone attachment process is also mainly performed manually, resulting in high manufacturing costs and a complex process.

Additionally, a conventional force-torque sensor includes a capacitance-based force-torque sensor that measures the magnitude and direction of an external force by measuring the capacitance between electrode plates. This method is easy to manage, allows for miniaturization, and is relatively inexpensive as it uses a single type of sensor, but it has the disadvantage of requiring multiple sensing apparatuses to be installed in various locations to achieve high accuracy. Additionally, due to the characteristics of the sensor, the capacitance method requires a grounding metal plate to serve as a reference point for capacitance measurement. This grounding metal plate must be connected to ground, and additional components are required to implement this. Additionally, the capacitance method had the disadvantage of being easily affected by external static electricity or electromagnetic fields.

Accordingly, research has been conducted from various angles on a force-torque sensor that minimizes components, can be miniaturized, has high impact durability, has low manufacturing costs, and can minimize the influence of external static electricity or electromagnetic fields.

### SUMMARY

A photocoupler-based 6-axis force-torque sensing apparatus according to the present disclosure may include: a deformable structure including a spring structure, which has a vertical displacement portion and a horizontal displacement portion and is elastically deformed by an external force, and a frame structure supporting the spring structure; a sensing substrate including a vertical displacement photocoupler, which is disposed below the vertical displacement portion to sense a vertical displacement thereof, and a horizontal displacement photocoupler, which is disposed horizontally outward of the horizontal displacement portion to sense a horizontal displacement thereof, and a sensing substrate support supporting the sensing substrate and coupled to the frame structure such that a gap of a predetermined range is formed between the spring structure and the sensing substrate.

The spring structure may include at least three beam portions arranged at regular intervals, extending radially in a horizontal direction from a central portion and connected to the frame structure; the vertical displacement portion may be a portion connected from the central portion to the frame structure in each beam portion; and the horizontal displacement portion may be a portion extending vertically downward from one widthwise end of the vertical displacement portion in each beam portion.

In addition, the spring structure include at least three beam portions extending radially in a horizontal direction from a central portion and connected to the frame structure, and at least three spring protrusions extending radially in a horizontal direction from a central portion, wherein the vertical displacement portions are the respective beam portions, and the horizontal displacement portions can be formed at the ends of linear extension portions extending radially in a horizontal direction from the central portion in each spring protrusion.

In addition, the vertical displacement photocoupler and the horizontal displacement photocoupler each include a light-emitting element that emits light and a light-receiving element that detects the light and converts it into an electrical signal according to its intensity. The light emitted from the light-emitting element of the vertical displacement photocoupler is reflected from a bottom surface of the vertical displacement portion and then collected by the light-receiving element of the vertical displacement photocoupler to detect a change in the gap between the vertical displacement photocoupler and the bottom surface of the vertical displacement portion. The light emitted from the light-emitting element of the horizontal displacement photocoupler is reflected from the horizontally outward surface of the horizontal displacement portion and then collected by the light-receiving element of the horizontal displacement photocoupler to detect a change in the gap between the horizontal displacement photocoupler and the outward surface of the horizontal displacement portion.

In addition, the sensing substrate may further include a data processing unit that receives an electrical signal corresponding to the intensity of light collected through the light-receiving elements of the vertical displacement photocoupler and the horizontal displacement photocoupler, and calculates the displacement of the spring structure based on the electrical signal.

In addition, the light-emitting element and the light-receiving element of the vertical displacement photocoupler may be arranged parallel to the bottom surface of the vertical displacement portion at a predetermined distance, and the light-emitting element and the light-receiving element of the horizontal displacement photocoupler may be arranged parallel to the outward surface of the horizontal displacement portion at a predetermined distance.

The apparatus may further include a cover that is coupled to the upper side of the spring structure and is coupled to an external force apparatus on the upper side to transmit an external force applied from the external force apparatus to the spring structure.

In addition, the spring structure may include a first beam portion, a second beam portion, and a third beam portion arranged at 120-degree intervals, wherein the first beam portion includes a first vertical displacement portion and a first horizontal displacement portion, the second beam portion includes a second vertical displacement portion and a second horizontal displacement portion, and the third beam portion includes a third vertical displacement portion and a third horizontal displacement portion. In addition, the sensing substrate may include a first vertical displacement photocoupler for measuring the displacement of the first vertical displacement portion, a first horizontal displacement photocoupler for measuring the displacement of the first horizontal displacement portion, a second vertical displacement photocoupler for measuring the displacement of the second vertical displacement portion, a second horizontal displacement photocoupler for measuring the displacement of the second horizontal displacement portion, a third vertical displacement photocoupler for measuring the displacement of the third vertical displacement portion, and a third horizontal displacement photocoupler for measuring the displacement of the third horizontal displacement portion, which may be disposed at positions corresponding to the first vertical displacement portion, the first horizontal displacement portion, the second vertical displacement portion, the second horizontal displacement portion, the third vertical displacement portion, and the third horizontal displacement portion, respectively.

Therein, the longitudinal direction of the first beam portion may be set as the x-axis, the direction orthogonal to the x-axis in the plane between the first beam portion and the second beam portion may be set as the y-axis, and the upward direction of the spring structure, which is the direction orthogonal to the x-axis and the y-axis, may be set as the z-axis.

In addition, by measuring the x-axis component Fₓ, the y-axis component F_{y}, and the z-axis component F_{z} of an external force, and an x-axis-based rotational moment Mₓ and a y-axis-based rotational moment M_{y} generated by the external force through the first vertical displacement portion, the first horizontal displacement portion, the second vertical displacement portion, the second horizontal displacement portion, the third vertical displacement portion, and the third horizontal displacement portion, the displacement Δd₁ of the first vertical displacement portion, the displacement Δd₂ of the first horizontal displacement portion, the displacement Δd₃ of the second vertical displacement portion, the displacement Δd₄ of the second horizontal displacement portion, the displacement Δd₅ of the third vertical displacement portion, and the displacement Δd₆ of the third horizontal displacement portion can be calculated as shown in Equations 1 to 6 below, respectively.

$$Δ {d}_{1} = - {F}_{z} / {k}_{dFzv} - {M}_{x} {r}_{s 1} / {k}_{rMxv} \qquad Equation 1 )$$

$$Δ {d}_{2} = - {F}_{z} / {k}_{dFzv} - {M}_{x} {r}_{s 1} sin ( π / 3 ) / {k}_{rMxv} + {M}_{y} {r}_{s 1} sin ( π / 6 ) / {k}_{rMxv} \qquad Equation 2 )$$

$$Δ {d}_{3} = - {F}_{z} / {k}_{dFzv} + {M}_{x} {r}_{s 1} sin ( π / 3 ) / {k}_{rMxv} + {M}_{y} {r}_{s 1} sin ( π / 6 ) / {k}_{rMxv} \qquad Equation 3 )$$

$$Δ {d}_{4} = {F}_{y} / {k}_{dFyh} + {M}_{x} ( h / 2 - c ) / {k}_{rMxh} + {M}_{z} / {k}_{dMzh} \qquad Equation 4 )$$

$$Δ {d}_{5} = - {F}_{x} sin ( π / 3 ) / {k}_{dFyh} - {F}_{y} sin ( π / 6 ) / {k}_{dFyh} - {M}_{x} ( h / 2 - c ) sin ( π / 6 ) / {k}_{rMxh} - {M}_{y} ( h / 2 - c ) sin ( π / 3 ) / {k}_{rMxh} + {M}_{z} / {k}_{dMzh} \qquad Equation 5 )$$

$$Δ {d}_{6} = {F}_{x} sin ( π / 3 ) / {k}_{dFyh} - {F}_{y} sin ( π / 6 ) / {k}_{dFyh} + {M}_{x} ( h / 2 - c ) sin ( π / 6 ) / {k}_{rMxh} + {M}_{y} ( h / 2 - c ) sin ( π / 3 ) / {k}_{rMxh} + {M}_{z} / {k}_{dMzh} \qquad Equation 6 )$$

In addition, the relationship between the displacement Δd₁ of the first vertical displacement portion, the displacement Δd₂ of the second vertical displacement portion, the displacement Δd₃ of the third vertical displacement portion, the displacement Δd₄ of the first horizontal displacement portion, the displacement Δd₅ of the second horizontal displacement portion, the displacement Δd₆ of the third horizontal displacement portion, and the x-axis component Fₓ, y-axis component F_{y}, the z-axis component F_{z} of the external force, the x-axis-based rotational moment Mₓ, the y-axis-based rotational moment M_{y}, a z-axis-based rotational moment M_{z} generated by the external force can be defined as in the following Equation 7.

$$Δ d = AF , \qquad Equation 7 )$$

$$A = [ \begin{matrix}0 & 0 & - \frac{1}{{k}_{dFzv}} & 0 & - \frac{{r}_{s 1}}{{k}_{rMxv}} & 0 \\ 0 & 0 & - \frac{1}{{k}_{dFzv}} & - \frac{{r}_{s 1} sin ( π / 3 )}{{k}_{rMxv}} & \frac{{r}_{s 1} sin ( π / 6 )}{{k}_{rMxv}} & 0 \\ 0 & 0 & - \frac{1}{{k}_{dFzv}} & \frac{{r}_{s 1} sin ( π / 3 )}{{k}_{rMxv}} & \frac{{r}_{s 1} sin ( π / 6 )}{{k}_{rMxv}} & 0 \\ 0 & \frac{1}{{k}_{dFyh}} & 0 & \frac{( h / 2 - c )}{{k}_{rMxh}} & 0 & \frac{1}{{k}_{dMzh}} \\ \frac{- sin ( π / 3 )}{{k}_{dFyh}} & \frac{- sin ( π / 6 )}{{k}_{dFyh}} & 0 & \frac{\begin{matrix}- ( h / 2 - \\ c ) sin ( π / 6 )\end{matrix}}{{k}_{rMxh}} & \frac{\begin{matrix}- ( h / 2 - \\ c ) sin ( π / 3 )\end{matrix}}{{k}_{rMxh}} & \frac{1}{{k}_{dMzh}} \\ \frac{sin ( π / 3 )}{{k}_{dFyh}} & \frac{- sin ( π / 6 )}{{k}_{dFyh}} & 0 & \frac{\begin{matrix}( h / 2 - \\ c ) sin ( π / 6 )\end{matrix}}{{k}_{rMxh}} & \frac{\begin{matrix}( h / 2 - \\ c ) sin ( π / 3 )\end{matrix}}{{k}_{rMxh}} & \frac{1}{{k}_{dMzh}}\end{matrix} ] ,$$

$$Δ d = [ \begin{matrix}Δ {d}_{1} \\ Δ {d}_{2} \\ Δ {d}_{3} \\ Δ {d}_{4} \\ Δ {d}_{5} \\ Δ {d}_{6}\end{matrix} ] ,$$

$$F = [ \begin{matrix}{F}_{x} \\ {F}_{y} \\ {F}_{z} \\ {M}_{x} \\ {M}_{y} \\ {M}_{z}\end{matrix} ]$$

wherein rₛ₁ is the position radius of the vertical displacement photocoupler, k_{rMxv} is the torsional spring constant of the vertical displacement portion due to the x-axis and y-axis rotational moments at rₛ₁, K_{dFzv} is the spring constant corresponding to the z-axis deformation of the vertical displacement portion at the point rₛ₁, rₛ₂ is the position radius of the horizontal displacement photocoupler, K_{rMxh} is the spring constant corresponding to the deformation of the horizontal displacement portion due to the x-axis and y-axis rotational moments at the point rₛ₂, K_{dFyh} is the spring constant corresponding to the deformation of the horizontal displacement portion caused by the y-axis directional force at the point rₛ₂, K_{rMzh} is the spring constant corresponding to the deformation of the horizontal displacement portion caused by the z-axis rotational moment at the point rₛ₂, h is the vertical thickness of the spring structure, and c is the vertical distance from the substrate of the sensing substrate to the horizontal displacement photocoupler.

Additionally, a calibration matrix G can be calculated as in Equation 8 below.

$$A = Δ d / F = G \qquad Equation 8 )$$

Additionally, a corrected calibration matrix G̅ can be defined as in Equation 9 below.

$$\overline{G} = {R}_{s}^{- 1} G \qquad Equation 9 )$$

A photocoupler-based 6-axis force-torque sensing method using a photocoupler-based 6-axis force-torque sensing apparatus according to the present disclosure comprises:

applying an external force to a spring structure that elastically deforms due to the external force; sensing a vertical displacement of the vertical displacement portion of the spring structure through a vertical displacement photocoupler disposed below the vertical displacement portion, and sensing a horizontal displacement of the horizontal displacement portion through a horizontal displacement photocoupler disposed horizontally outward of the horizontal displacement portion; receiving, at a data processing unit, an electrical signal corresponding to an intensity of light collected by a light-receiving element of the vertical displacement photocoupler and by a light-receiving element of the horizontal displacement photocoupler, and calculating a displacement of the spring structure based thereon; and calculating a magnitude and direction of the external force applied to the spring structure using the displacement of the spring structure at the data processing unit.

### BRIEF DESCRIPTION OF THE DRAWINGS

Embodiments of the present disclosure will be described below with reference to the accompanying drawings, wherein like reference numerals refer to like elements, but the present disclosure is not limited thereto.

FIG. 1 is an exploded perspective view of a 6-axis force-torque sensing apparatus according to a first embodiment of the present disclosure, viewed from above.

FIG. 2 is an exploded perspective view of a 6-axis force-torque sensing apparatus according to the first embodiment of the present disclosure, viewed from below.

FIG. 3 is a perspective view of a 6-axis force-torque sensing apparatus assembled according to the first embodiment of the present disclosure.

FIG. 4 is a diagram illustrating the arrangement of a beam portion and a photocoupler of a 6-axis force-torque sensing apparatus according to the first embodiment of the present disclosure.

FIG. 5 is a diagram illustrating the arrangement of a beam portion and a photocoupler of a 6-axis force-torque sensing apparatus according to the first embodiment of the present disclosure.

FIG. 6 is a diagram illustrating a top view of a sensing substrate of a 6-axis force-torque sensing apparatus according to the first embodiment of the present disclosure.

FIG. 7 is a diagram illustrating a bottom view of a sensing substrate of a 6-axis force-torque sensing apparatus according to the first embodiment of the present disclosure.

FIG. 8A is a diagram illustrating an axis setting and a length setting of a spring structure according to the first embodiment of the present disclosure, and FIG. 8B is a diagram illustrating a length setting of a beam portion and a support portion of the spring structure.

FIG. 9A is a diagram illustrating a deformation force acting on each of three beam portions and a total deformation force according to the first embodiment of the present disclosure, and FIG. 9B is a vector composition diagram illustrating the process in which the deformation forces acting on the three beam portions are vectorially combined to form a total deformation force.

FIGS. 10A and 10B are diagrams for explaining a method for obtaining a linear spring stiffness coefficient in the z-axis direction due to a force F_{z} in the z-axis direction of an external force.

FIGS. 11A and 11B are diagrams for explaining a method for obtaining a torsional spring stiffness coefficient with respect to the x-axis due to an x-axis-based rotational moment Mₓ of an external force.

FIGS. 12A and 12B are diagrams for explaining a method for obtaining a linear spring stiffness coefficient in the y-axis direction by a force F_{y} in the y-axis direction of an external force.

FIGS. 13A and 13B are diagrams for explaining a method for obtaining a torsional spring stiffness coefficient with respect to the z-axis by a z-axis-based rotational moment M_{z} of an external force.

FIG. 14 is a graph showing experimental results comparing the force-torque measurement results of a 6-axis force-torque sensing apparatus according to an embodiment of the present disclosure and a commercial 6-axis force-torque sensing apparatus, ATI-MINI85, according to the prior art.

FIG. 15 is an exploded perspective view of a 6-axis force-torque sensing apparatus according to a second embodiment of the present disclosure, viewed from above.

FIG. 16 is a perspective view of a 6-axis force-torque sensing apparatus assembled according to the second embodiment of the present disclosure.

FIG. 17 is a flowchart showing a 6-axis force-torque sensing method according to the present disclosure.

### DETAILED DESCRIPTION OF EMBODIMENTS

Hereinafter, specific embodiments for carrying out the present disclosure will be described in detail with reference to the accompanying drawings. However, in the following description, specific descriptions of well-known functions or configurations will be omitted if they are likely to unnecessarily obscure the gist of the present disclosure.

In the accompanying drawings, identical or corresponding components are assigned the same reference numerals. Additionally, in the description of the embodiments below, a redundant description of identical or corresponding components may be omitted. However, even if a description of a component is omitted, it is not intended that such a component is excluded from an embodiment.

The advantages and features of the embodiments disclosed herein, and methods for achieving them, will become apparent with reference to the embodiments described below in conjunction with the accompanying drawings. However, the present disclosure is not limited to the embodiments disclosed below but may be embodied in various different forms. These embodiments are provided only to fully disclose the present invention and to fully inform one of ordinary skill in the art of the scope of the disclosure.

Unless otherwise defined, all terms (including technical and scientific terms) used herein may be used in a meaning that can be commonly understood by one of ordinary skill in the art to which the present disclosure belongs. Also, terms defined in commonly used dictionaries are not to be interpreted ideally or excessively unless explicitly defined.

For example, the term “technology” may refer to systems, methods, computer-readable instructions, modules, algorithms, hardware logic, and/or operations as permitted by the context described above and throughout the document.

The terms used in this specification will be briefly described, and the disclosed embodiments will be described in detail. The terms used herein have been selected from general terms that are currently widely used, while taking into account their functions in the present disclosure. However, these terms may change depending on the intent of a person skilled in the relevant art, judicial precedents, or the emergence of new technologies. In addition, in certain cases, there are terms arbitrarily selected by the applicant, and in such cases, the meanings thereof will be described in detail in the corresponding portion of the description of the disclosure. Therefore, the terms used in the present disclosure should be defined based on their meanings and the overall content of the present disclosure, rather than their simple names.

In this specification, singular expressions include plural expressions unless the context clearly indicates otherwise. In addition, plural expressions include singular expressions unless the context clearly indicates otherwise. Throughout this specification, when a portion is stated to “comprise” a component, this means that it may further include other components and does not exclude other components, unless otherwise stated.

In the present disclosure, terms such as “comprise” and “comprising” may indicate the presence of features, steps, operations, elements, and/or components, but such terms do not preclude the addition of one or more other functions, steps, operations, elements, components, and/or combinations thereof.

In the present disclosure, when a component is referred to as being “coupled,” “combined,” “connected,” “associated” with, or “reacting” with another component, the component may be directly coupled, combined, connected to, associated with, and/or react with, the other component, but is not limited thereto. For example, there may be one or more intermediate components between one component and another component. Additionally, in the present disclosure, “and/or” may include each of one or more of the listed items or a combination of at least a portion of one or more of the listed items.

In the present disclosure, terms such as “first” and “second” are used to distinguish a component from another component, and the aforementioned components are not limited by these terms. For example, a “first” component may be an element of the same or similar form as a “second” component.

In this specification, a ‘portion’ or ‘module’ includes a unit realized by hardware or software, or a unit realized using both; one unit may be realized using two or more hardware components, and two or more units may be realized by one hardware component.

In this specification, the vertical direction refers to a direction perpendicular to the ground, i.e., the z-axis direction in the drawings, and the horizontal direction refers to a direction parallel to the ground, i.e., the x-axis and y-axis directions in the drawings.

In this specification, screw holes may be replaced with through-holes, and through-holes may be replaced with screw holes. Here, when coupling two parts through two through-holes, various other coupling methods can be used instead of screw coupling, including pin joints, tab-slot joints, and mortise-tenon joints.

The system described below constitutes one embodiment and is not intended to limit the scope of the claims to any one particular operating environment. It may be used in other environments without departing from the technical spirit and scope of the claimed subject matter.

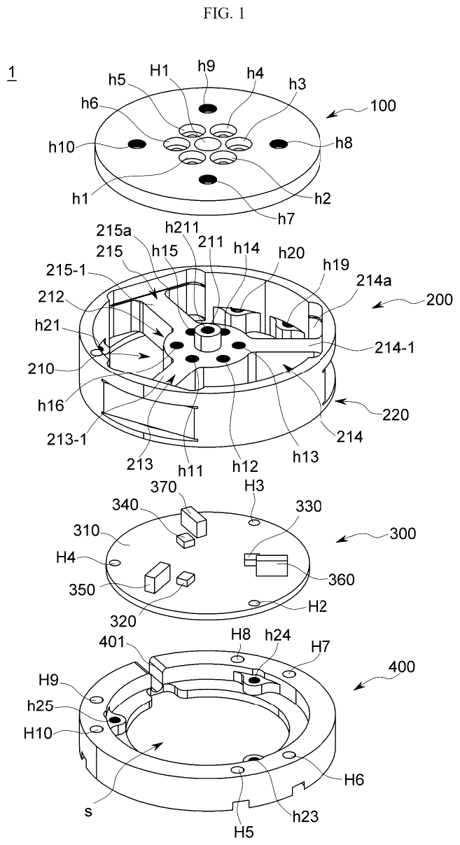

Hereinafter, a 6-axis force-torque sensing apparatus (1) according to a first embodiment of the present disclosure will be described with reference to FIGS. 1 to 7.

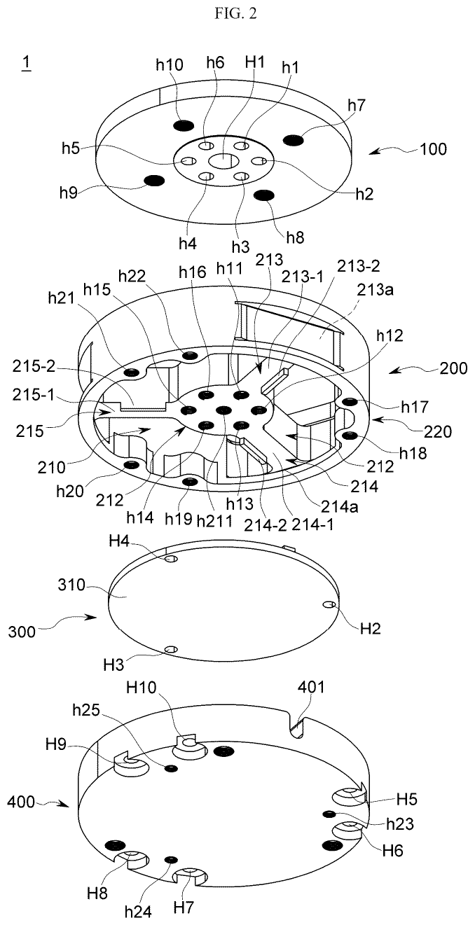

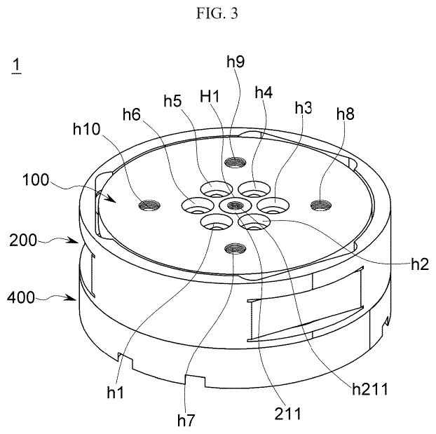

FIGS. 1 and 2 are exploded perspective views of a 6-axis force-torque sensing apparatus (1) according to a first embodiment of the present disclosure. FIG. 1 shows an exploded perspective view from above, and FIG. 2 shows an exploded perspective view from below. In addition, FIG. 3 shows a perspective view of the 6-axis force-torque sensing apparatus (1) in which the components shown in FIGS. 1 and 2 are assembled.

Referring to FIGS. 1 to 3, a 6-axis force-torque sensing apparatus (1) according to the first embodiment of the present disclosure includes a cover (100) to which an external force is applied, a deformable structure (200) that is elastically deformed by the external force, a photocoupler-based sensing substrate (300) that senses the deformation of the deformable structure (200), and a sensing substrate support (400) that supports the sensing substrate (300).

In this specification, an external force refers to a force applied to the cover (100) from the outside of the cover (100). For example, although not shown in the drawings, a predetermined external apparatus may be coupled to the cover (100), and a predetermined external force may be applied to the cover (100) from the coupled external apparatus. Hereinafter, an external apparatus that is coupled to the cover (100) as described above and applies a predetermined external force is referred to as an external force apparatus. Additionally, the external force is not limited to the force applied to the cover (100) from an external force apparatus, but also includes forces applied to the cover (100) in various other ways.

In addition, the cover (100) and the deformable structure (200) can be grouped as an upper structure to which the external force is transmitted, and the sensing substrate (300) and the sensing substrate support (400) can be grouped as a lower structure for measuring the external force. That is, according to the present disclosure, a 6-axis force-torque sensing apparatus (1) simplified into an upper structure and a lower structure can be provided.

The cover (100) is a force transmission structure for receiving an external force and transmitting it to the deformable structure (200), and can be coupled to the outside of the deformable structure (200).

The cover (100) may be configured to be coupled to the upper side of the spring structure (210) of the deformable structure (200) and transmit an external force applied from the upper side of the cover (100) to the spring structure (210). In addition, the cover (100) is not limited to the above-described form and can be coupled to the spring structure (210) in various ways, and can be implemented to transmit an external force applied from various directions to the spring structure (210).

The cover (100) can be designed in the shape of a circular plate of uniform thickness. In this case, the uniform thickness of the cover (100) can minimize variables occurring during the external force transmission process, and the circular structure with a constant radius can contribute to improving the accuracy of measuring the magnitude and direction of the external force. Additionally, the cover (100) may be made of a rigid, inelastic metal to absorb unnecessary external shocks and prevent damage to the spring structure (210). In addition, the cover (100) is not limited to the above-described shape and material and can be implemented in various shapes with various materials.

A cover through-hole (H1) for coupling between an external force apparatus and the spring structure (210) may be formed in the cover (100). The upper protrusion (211) of the spring structure (210) can be inserted into the cover through-hole (H1), and the inner surface of the cover through-hole (H1) can be formed in a shape that corresponds to the outer surface of the protrusion (211). In addition, the cover through-hole (H1) may be formed at the center of gravity of the cover (100) so that the magnitude and direction of the external force transmitted from the external force apparatus are fully transmitted to the spring structure (210), but is not limited thereto and may be formed at various locations.

Additionally, vertical deformable structure coupling screw holes (h1, h2, h3, h4, h5, h6) for screw coupling with the spring structure (210) can be formed in the central portion (101) of the cover (100). Here, the central portion (101) of the cover (100) may be an area within a predetermined distance from the center of gravity of the cover (100), and may be an area centered on the cover through-hole (H1).

Here, at least three deformable structure coupling screw holes (h1, h2, h3, h4, h5, h6) are formed at equiangular intervals centered on the cover through-hole (H1) so that the magnitude and direction of the external force transmitted from the external force apparatus can be designed to be fully transmitted to the spring structure (210). Preferably, 6 deformable structure coupling screw holes (h1, h2, h3, h4, h5, h6) can be formed at 60-degree intervals centered on the cover through-hole (H1).

Additionally, vertical external force apparatus coupling screw holes (h7, h8, h9, h10) for screw coupling with an external force apparatus can be formed at the edge portion (102) of the cover (100). Here, the edge portion (102) of the cover (100) may be an area between the central portion (101) of the cover (100) and the edge.

Here, the external force apparatus coupling screw holes (h7, h8, h9, h10) are formed at equiangular intervals on the outside of the deformable structure coupling screw holes (h1, h2, h3, h4, h5, h6) centered on the cover through-hole (H1), so that the magnitude and direction of the external force transmitted from the external force apparatus can be designed to be fully transmitted to the spring structure (210). Preferably, four external force apparatus coupling screw holes (h7, h8, h9, h10) can be formed at 90-degree intervals centered on the cover through-hole (H1).

The deformable structure (200) may include a spring structure (210) that is coupled to the cover (100) to receive an external force, and a frame structure (220) that supports the spring structure (210) and is coupled to a sensing substrate support (400) to position the sensing substrate (300) within a predetermined separation distance from the spring structure (210).

The frame structure (220) can be provided as a cylindrical structure with an open top and bottom.

Therein, a spring structure (210) is supported on the inside of a frame structure (220), and a cover (100) in the shape of a circular plate that is coupled to the upper side of the spring structure (210) can be inserted into the upper interior of the frame structure (220). At this time, the inner diameter of the cylinder at the top of the frame structure (220) is formed to be larger than the diameter of the cover (100), so that a predetermined gap can be formed between the cover (100) and the frame structure (220), and through this design, vertical movement and tilting of the cover (100) due to external force can be smoothly induced.

Additionally, a sensing substrate support (400) can be coupled to the lower side of the frame structure (220). Here, vertical sensing substrate support coupling screw holes (h17, h18, h19, h20, h21, h22) for screw coupling with the sensing substrate support (400) can be formed at regular intervals at the bottom of the frame structure (220).

In addition, the frame structure (220) can be designed to have a uniform thickness on the side of the cylindrical shape, so as to minimize variables occurring during the external force transmission process.

The spring structure (210) is deformed according to the magnitude and direction of the external force transmitted through the cover (100), and the displacement of the spring structure (210) is sensed through a plurality of photocouplers (320, 330, 340, 350, 360, 370) installed on the sensing substrate (300).

Accordingly, the spring structure (210) can be made of a material that is elastically deformable and has a high reflectivity for the light emitted from the photocoupler (320, 330, 340, 350, 360, 370). For example, the spring structure (210) may be made of an elastic metal such as AL7075-T6. In this case, since the displacement of the spring structure (210) can be directly sensed through the photocoupler (320, 330, 340, 350, 360, 370), a separate medium for the sensor to sense the displacement of the elastic body is not required, so not only is manufacturing and management easy, but the time and cost required for manufacturing and management can be reduced. Additionally, the 6-axis force-torque sensing apparatus can be made more compact, saving installation space. In addition, the spring structure (210) is not limited thereto and can be implemented with various types of materials.

In addition, the spring structure (210) can be designed to have a uniform thickness in the vertical direction to minimize variables that occur during the external force transmission process.

Additionally, the spring structure (210) can be provided as a cross-shaped elastic beam-type spring structure. In detail, the spring structure (210) may be composed of a central portion (212), which is an area within a predetermined distance from the center of gravity, and at least three beam portions (213, 214, 215) which extend radially in a horizontal direction from the central portion (212) and have their ends fixed to a frame structure (220).

According to the spring structure (210) with a cross-shaped elastic beam-type spring structure as described above, at least one of normal deformation due to a vertical force or torque and shear deformation due to a horizontal force or torque can occur in at least one of the three beam portions (213, 214, 215), depending on the magnitude and direction of the external force.

A protrusion (211) in which a vertical screw hole (h211) is formed may be formed on top of the central portion (212) of the spring structure (210). The protrusion (211) can be inserted into the cover through-hole (H1) of the cover (100) from below and can be screw-coupled to an external apparatus through the screw hole (h211) while inserted in the cover through-hole (H1) of the cover (100). Here, the protrusion (211) can be formed in a shape in which its outer surface corresponds to the inner surface of the cover through-hole (H1), and the screw hole (h211) of the protrusion (211) can be formed in a shape in which the upper end is open and the lower end is closed. Additionally, the screw hole (h211) of the protrusion (211) can be formed at the top center of gravity of the spring structure (210). Further, the present disclosure is not limited thereto, and the protrusion (211) and the screw hole (h211) can be formed in various ways.

Additionally, vertical cover coupling screw holes (h11, h12, h13, h14, h15, h16) for screw coupling with the cover (100) may be formed in the central portion (212) of the spring structure (210). In addition, the cover coupling screw holes (h11, h12, h13, h14, h15, h16) can be formed in the same number of corresponding positions as the deformable structure coupling screw holes (h1, h2, h3, h4, h5, h6) of the cover (100), and the cover (100) and the spring structure (210) can be coupled by coupling screws to the corresponding screw holes of each pair. For example, 6 deformable structure coupling screw holes (h1, h2, h3, h4, h5, h6) and 6 cover coupling screw holes (h11, h12, h13, h14, h15, h16) can be formed at the same distance at 60-degree intervals centered on the cover through-hole (H1) and the protrusion (211).

The beam portions (213, 214, 215) of the spring structure (210) can be formed at equiangular intervals centered on the central portion (212) of the spring structure (210). Preferably, three beam portions (213, 214, 215) can be formed at 120-degree intervals. Accordingly, the spring structure (210) can be stably fixed to the frame structure (220) and can be deformed to reflect the directionality of the external force.

In addition, the spring structure (210) may be a single, integrally formed configuration in which the central portion (212) and the beam portions (213, 214, 215) are integrated, or may be configured such that the central portion (212) and the beam portions (213, 214, 215) are provided as separate components and then coupled.

If the spring structure (210) has a single configuration, it may be composed of a single material that can be elastically deformed by an external force.

Meanwhile, if the central portion (212) and the beam portions (213, 214, 215) of the spring structure (210) are separate components, they may be composed of the same material or different materials. For example, the central portion (212) may be a circular plate made of a non-elastic material, and the beam portions (213, 214, 215) may be made of an elastic material, or the central portion (212) and the beam portions (213, 214, 215) may be made of elastic materials of different materials.

In addition, the beam portions (213, 214, 215) may include vertical displacement portions (213-1, 214-1, 215-1) connected from the central portion (212) to the spring structure (210), and horizontal displacement portions (213-2, 214-2, 215-2) extending vertically downward from one widthwise end of the vertical displacement portions (213-1, 214-1, 215-1). Here, the horizontal displacement portions (213-2, 214-2, 215-2) can be formed to a predetermined length along the longitudinal direction of the vertical displacement portions (213-1, 214-1, 215-1). Here, the longitudinal direction of the vertical displacement portions (213-1, 214-1, 215-1) is a horizontal direction connected from the central portion (212) to the spring structure (210), and the width direction of the vertical displacement portions (213-1, 214-1, 215-1) is a horizontal direction that is perpendicular to the longitudinal direction of the vertical displacement portions (213-1, 214-1, 215-1).

In addition, the vertical displacement portions (213-1, 214-1, 215-1) can be formed as a linear structure with a predetermined width and vertical height and having parallel top and bottom surfaces, and the horizontal displacement portions (213-2, 214-2, 215-2) can be formed as a thin rectangular plate-shaped structure. In addition, the vertical height of the horizontal displacement portions (213-2, 214-2, 215-2) can be formed to be greater than the vertical height of the vertical displacement portions (213-1, 214-1, 215-1), and can be designed to be longer than the vertical deformation range of the spring structure (210) due to an external force.

According to the configuration of the vertical displacement portions (213-1, 214-1, 215-1) and horizontal displacement portions (213-2, 214-2, 215-2) as described above, the vertical displacement of each beam portion (213, 214, 215) can be measured by sensing the vertical deformation of the vertical displacement portions (213-1, 214-1, 215-1) through the vertical displacement photocouplers (320, 330, 340). In addition, the horizontal displacement of each beam portion (213, 214, 215) can be measured by sensing the horizontal deformation of the horizontal displacement portions (213-2, 214-2, 215-2) through the horizontal displacement photocouplers (350, 360, 370).

In addition, support portions (213a, 214a, 215a) extending in the width direction on both sides of the beam portions (213, 214, 215) are provided at the longitudinal ends of the beam portions (213, 214, 215), and as both ends of the support portions (213a, 214a, 215a) are fixed to the frame structure (220), the spring structure (210) can be coupled to the frame structure (220).

Additionally, the spring structure (210) may be formed integrally with the frame structure (220), or may be provided as a separate component from the frame structure (220) and coupled to the frame structure (220).

Here, when the spring structure (210) and the frame structure (220) are integrally formed, the material of the frame structure (220) may be composed of an elastic material identical to the material of the spring structure (210). In this case, since the frame structure (220) and the spring structure (210) are composed of the same material, the time and cost required for manufacturing and management can be reduced. In addition, since not only the spring structure (210) but also the frame structure (220) is elastically deformed by an external force, a wider variety of external forces can be reflected in the deformation of the deformable structure (200), thereby improving the force-torque measurement range of the sensing substrate (300) and increasing its utility.

Meanwhile, when the spring structure (210) and the frame structure (220) are provided as separate structures and then coupled, the material of the frame structure (220) may be the same as or different from the material of the spring structure (210). For example, the frame structure (220) may be composed of a rigid, non-elastic metal material. In this case, the frame structure (220) can remain undeformed under an external force and maintain a stable, fixed structure, thereby minimizing the force-torque measurement variables of the sensing substrate (300) and increasing accuracy.

The sensing substrate support (400) is coupled to the deformable structure (200) on its upper side and supports the sensing substrate (300) on its inner side, thereby positioning the sensing substrate (300) within a predetermined gap below the spring structure (210).

Specifically, the sensing substrate support (400) is formed as a cylindrical structure with an accommodating space (s) formed on the inside and an open top, such that the sensing substrate (300) is coupled to the accommodating space (s), and the open top can be coupled to the frame structure (220) of the deformable structure (200).

Here, the gap between the deformable structure (200) and the sensing substrate (300) can be set differently depending on the deformation range of the deformable structure (200), and can be set to maintain a non-contact state with the sensing substrate (300) even when the deformable structure (200) is deformed to its maximum.

Additionally, deformable structure coupling through-holes (H5, H6, H7, H8, H9, H10) for coupling with the frame structure (220) may be formed at regular intervals on the top of the sensing substrate support (400). The deformable structure coupling through-holes (H5, H6, H7, H8, H9, H10) can be provided in a number and shape corresponding to the sensing substrate support coupling screw holes (h17, h18, h19, h20, h21, h22) of the frame structure (220). Here, screws (not shown) can be inserted from the lower side of the sensing substrate support (400) through the deformable structure coupling through-holes (H5, H6, H7, H8, H9, H10) and fastened to the sensing substrate support coupling screw holes (h17, h18, h19, h20, h21, h22), respectively. In addition, the deformable structure coupling through-holes (H5, H6, H7, H8, H9, H10) can be formed to have a step that is narrower at the top than at the bottom, so that the screw head can be caught and fixed on the step.

Additionally, substrate coupling screw holes (h23, h24, h25) for coupling with the sensing substrate (300) can be formed at regular intervals on the inside of the sensing substrate support (400). The substrate coupling screw holes (h23, h24, h25) can be provided in a number and shape corresponding to the sensing substrate support coupling through-holes (H2, H3, H4) of the sensing substrate (300), and can be provided at corresponding positions. Here, screws (not shown) can be fastened to the substrate coupling screw holes (h23, h24, h25) through the sensing substrate support coupling through-holes (H2, H3, H4) from the upper side of the sensing substrate (300), respectively.

Additionally, the sensing substrate support (400) may further be provided with an external connection portion (401) through which a wire connected to the sensing substrate (300) can be connected to an external apparatus.

The sensing substrate (300) may be configured with a plurality of photocouplers (320, 330, 340, 350, 360, 370) on a substrate (310) on which a conductive pattern is formed.

The substrate (310) is for physically mounting electronic components and providing electrical connections to form an electronic circuit, may be a Printed Circuit Board (PCB), and may be provided as any one of a Flexible Printed Circuit Board (FPCB), a Ceramic Substrate, a Low Temperature Co-fired Ceramic (LTCC), a Metal Core PCB (MCPCB), and a Glass Fiber Substrate. Additionally, it may be a Hybrid Substrate composed of a mixture of various substrate materials, or may be composed of a Multilayer Substrate. Additionally, the substrate (310) may be provided in a circular plate shape, and for example, may be provided with a diameter of 31 mm. Additionally, without limitation, various types of substrates may be provided in various shapes.

Additionally, sensing substrate support coupling through-holes (H2, H3, H4) for coupling with the sensing substrate support (400) may be formed at regular intervals at the edge of the substrate (310) of the sensing substrate (300). The sensing substrate support coupling through-holes (H2, H3, H4) may be provided in a number and shape corresponding to the substrate coupling screw holes (h23, h24, h25) of the sensing substrate support (400) and may be provided at corresponding positions.

The photocoupler (320, 330, 340, 350, 360, 370) is configured to include a light-emitting element (321, 331, 341, 351, 361, 371) and a light-receiving element (322, 332, 342, 352, 362, 372).

The light-emitting element (321, 331, 341, 351, 361, 371) is configured to emit a predetermined light at regular time intervals or according to a light-emission signal received from a data processing unit (393). For example, the light-emitting element (321, 331, 341, 351, 361, 371) may be an LED that emits infrared rays.

The light-receiving element (322, 332, 342, 352, 362, 372) is configured to sense light and convert it into an electrical signal according to its intensity. For example, it may be composed of any one of a photodiode, a phototransistor, and a photothyristor.

Each photocoupler (320, 330, 340, 350, 360, 370) can be designed to emit a predetermined light from a light-emitting element (321, 331, 341, 351, 361, 371) toward a spring structure (210) at a predetermined angle, collect the light reflected from the spring structure (210) at a light-receiving element (322, 332, 342, 352, 362, 372), and transmit an electrical signal corresponding to the intensity of the collected light to a data processing unit (393). For example, by processing light emission and reception at a rate of 1 kHz or higher of a photocoupler (320, 330, 340, 350, 360, 370) and transmitting the sampling data to a data processing unit (393), the displacement of the spring structure (210) can be sensed in real time. Here, the intensity of light collected at the light-receiving element (322, 332, 342, 352, 362, 372) is measured differently depending on the gap between each photocoupler (320, 330, 340, 350, 360, 370) and the spring structure (210), and thus serves as position information indicating the displacement of the spring structure (210).

At least 6 photocouplers (320, 330, 340, 350, 360, 370) can be arranged at predetermined intervals on the substrate (310), and can sense the displacement of the spring structure (210) at each location.

For example, at least one photocoupler (320, 330, 340, 350, 360, 370) may be disposed below each of the three beam portions (213, 214, 215) of the spring structure (210), so that the photocouplers (320, 330, 340, 350, 360, 370) may be designed to sense the displacement of the beam portions (213, 214, 215) at their corresponding positions.

In addition, the photocouplers (320, 330, 340, 350, 360, 370) may be provided as vertical displacement photocouplers (320, 330, 340) that sense vertical deformation of the spring structure (210) and horizontal displacement photocouplers (350, 360, 370) that sense horizontal deformation of the spring structure (210). Here, when the vertical displacement photocouplers (320, 330, 340) and the horizontal displacement photocouplers (350, 360, 370) are arranged in pairs adjacent to each other, the vertical deformation and the horizontal deformation of the spring structure (210) can be sensed simultaneously at a predetermined position.

Using this, a pair of vertical displacement photocouplers (320, 330, 340) and horizontal displacement photocouplers (350, 360, 370) can be disposed adjacent to each beam portion (213, 214, 215) of the spring structure (210).

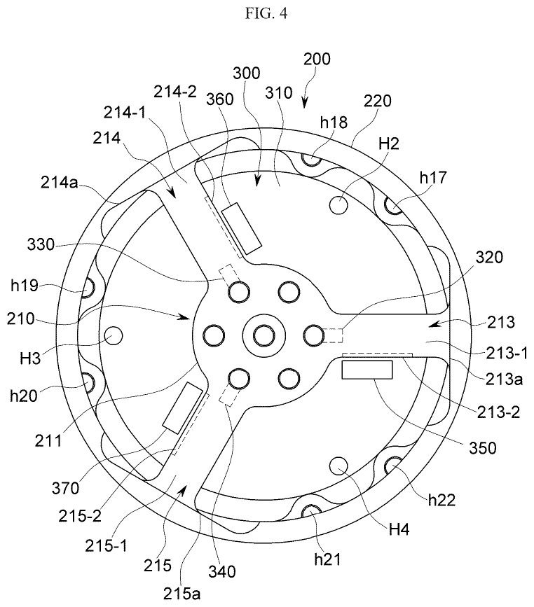

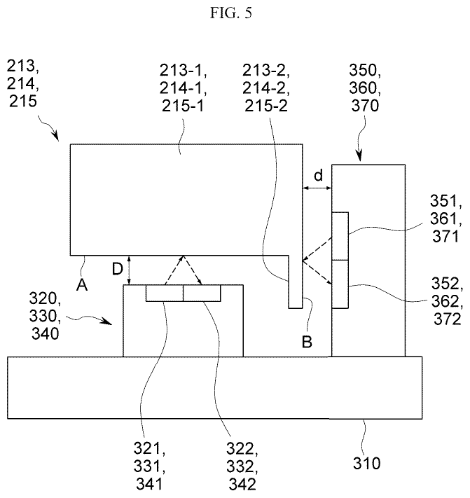

FIGS. 4 and 5 illustrate a schematic arrangement between the beam portions (213, 214, 215) and the photocouplers (320, 330, 340, 350, 360, 370). FIG. 4 is a top-down view illustrating a configuration in which a deformable structure (200) with three beam portions (213, 214, 215) on a spring structure (210) is disposed above a sensing substrate (300), wherein photocouplers (320, 330, 340, 350, 360, 370) are configured on a substrate (310). In addition, FIG. 5 is a view of a configuration in which a pair of vertical displacement photocouplers (320, 330, 340) and horizontal displacement photocouplers (350, 360, 370) are disposed adjacent to the beam portions (213, 214, 215), as viewed from the central portion (212) of the spring structure (210) toward the longitudinal direction of the beam portions (213, 214, 215). Here, the longitudinal direction of the beam portions (213, 214, 215) refers to the longitudinal direction of the vertical displacement portions (213-1, 214-1, 215-1), and is the direction penetrating the plane of the drawing in FIG. 5.

Referring to FIGS. 4 and 5, vertical displacement photocouplers (320, 330, 340) may be disposed below the vertical displacement portions (213-1, 214-1, 215-1) of the beam portions (213, 214, 215), and horizontal displacement photocouplers (350, 360, 370) may be disposed horizontally outward of the horizontal displacement portions (213-2, 214-2, 215-2). Specifically, a first vertical displacement photocoupler (320) may be disposed below a vertical displacement portion (213-1) of a first beam portion (213), and a first horizontal displacement photocoupler (350) may be disposed below a horizontal displacement portion (213-2) of the first beam portion (213). Additionally, a second vertical displacement photocoupler (330) may be disposed below the vertical displacement portion (214-1) of the second beam portion (214), and a second horizontal displacement photocoupler (360) may be disposed below the horizontal displacement portion (214-2) of the second beam portion (214). Additionally, a third vertical displacement photocoupler (340) may be disposed below the vertical displacement portion (215-1) of the third beam portion (215), and a third horizontal displacement photocoupler (370) may be disposed below the horizontal displacement portion (215-2) of the third beam portion (215).

Here, the light-emitting element (321, 331, 341) and the light-receiving element (322, 332, 342) of each vertical displacement photocoupler (320, 330, 340) can be arranged parallel to the bottom surface (A) of each vertical displacement portion (213-1, 214-1, 215-1). Likewise, the light-emitting element (351, 361, 371) and the light-receiving element (352, 362, 372) of each horizontal displacement photocoupler (350, 360, 370) can be arranged parallel to the horizontally outward surface (B) of each horizontal displacement portion (213-2, 214-2, 215-2). In addition, the vertical reference gap (D), which is the gap between the vertical displacement portions (213-1, 214-1, 215-1) of each beam portion (213, 214, 215) and the vertical displacement photocouplers (320, 330, 340) when no external force is applied, can be designed to have a constant predetermined value. Likewise, the horizontal reference gap (d), which is the gap between the horizontal displacement portions (213-2, 214-2, 215-2) and the horizontal displacement photocouplers (350, 360, 370) when no external force is applied, can be designed to have a constant predetermined value. Here, the vertical reference gap (D) and the horizontal reference gap (d) may be designed to have the same value or different values.

According to the arrangement as described above, by analyzing the light emitted from the light-emitting element (321, 331, 341) of the vertical displacement photocoupler (320, 330, 340), reflected from the bottom surface (A) of the vertical displacement portion (213-1, 214-1, 215-1), and then collected by the light-receiving element (322, 332, 342) of the vertical displacement photocoupler (320, 330, 340), a change in the gap between the vertical displacement portion (213-1, 214-1, 215-1) and the vertical displacement photocoupler (320, 330, 340) can be sensed, thereby measuring the vertical displacement of the vertical displacement portion (213-1, 214-1, 215-1). Likewise, by analyzing the light emitted from the light-emitting element (351, 361, 371) of the horizontal displacement photocoupler (350, 360, 370), reflected from the outward surface (B) of the horizontal displacement portion (213-2, 214-2, 215-2), and then collected by the light-receiving element (352, 362, 372) of the horizontal displacement photocoupler (350, 360, 370), a change in the gap between the horizontal displacement portion (213-2, 214-2, 215-2) and the horizontal displacement photocoupler (350, 360, 370) can be sensed, thereby measuring the horizontal displacement of the horizontal displacement portion (213-2, 214-2, 215-2).

Meanwhile, since the 6-axis force-torque sensing apparatus (1) according to the present disclosure is structured such that an external force is applied from the upper side of the spring structure (210), the vertical deformation of the spring structure (210) occurs within a relatively large range, and the horizontal deformation occurs within a relatively small range. Accordingly, the vertical displacement photocoupler (320, 330, 340) can be provided as an optical sensor capable of stably measuring a large range of displacement, and can be, for example, a TCRT1000 model. Additionally, the horizontal displacement photocoupler (350, 360, 370) may be provided as an optical sensor capable of precisely sensing a small range of displacement with a sensitive and fast response, and may be, for example, a QRE1113GR model. In addition, the present disclosure is not limited thereto, and various types of vertical displacement photocouplers (320, 330, 340) and horizontal displacement photocouplers (350, 360, 370) may be provided.

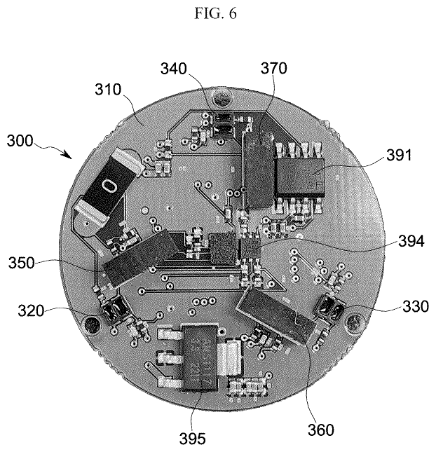

Additionally, a communication unit (391), a data processing unit (393), a temperature sensor (394), a voltage regulator (395), and a data processing unit debugger (396) may be further configured on the substrate (310) of the sensing substrate (300). In this regard, FIG. 6 shows the top side of the sensing substrate (300), and FIG. 7 shows the bottom side of the sensing substrate (300).

The communication unit (391) is a communication module configured to communicate with other apparatuses and can transmit data measured by the photocouplers (320, 330, 340, 350, 360, 370) to a predetermined external apparatus. For example, the communication unit (391) may be configured as a CAN transceiver, in which case a 5-Mbps CAN FD communication method may be used. In addition, the communication unit (391) is not limited to a specific communication method, and various types of communication modules and connection methods can be utilized.

The data processing unit (393) receives an electrical signal corresponding to the intensity of light measured by the light-receiving element (322, 332, 342, 352, 362, 372) of the photocoupler (320, 330, 340, 350, 360, 370), calculates the displacement of the spring structure (210) based thereon, and can calculate the magnitude and direction of the external force using this displacement.

Additionally, the data processing unit (393) can receive measurement data from the inertial measurement unit (392) and reflect it into the calculation of the magnitude and direction of the external force. In this process, the temperature compensation function of the data processing unit (393) is reflected in the calculation of the magnitude and direction of the external force, thereby reducing measurement errors due to temperature changes. Here, the temperature value of the 6-axis force-torque sensing apparatus (1) measured by the temperature sensor (394) can be transmitted to the data processing unit (393).

Additionally, the data processing unit (393) can be connected to other components configured on the sensing substrate (300) to control the entire sensing system for smooth operation.

An example of the data processing unit (393) is a Microcontroller Unit (MCU), but various types of data processing units may be used without being limited thereto.

Additionally, the data processing unit (393) may be configured to include an Analog-to-Digital Converter (ADC) that converts an analog signal measured from the photocouplers (320, 330, 340, 350, 360, 370) and the temperature sensor (394) into a digital signal. For example, the analog-to-digital converter may be designed to process digital signals at 16 bits and 3.6 MSPS. Additionally, an analog-to-digital converter may be separately provided on the substrate (310) to transmit analog signals measured from the photocouplers (320, 330, 340, 350, 360, 370) and the temperature sensor (394) to the data processing unit (393).

The temperature sensor (394) is a sensor that measures the temperature of the sensing substrate (300) and can be designed to enable precise temperature measurement. For example, a temperature sensor (394) having a temperature accuracy of 0.1° C. can be applied.

The voltage regulator (395) is a component for stably supplying voltage to components on the sensing substrate (300) through power conversion and minimizing noise. For example, the voltage regulator (395) may be a Low Dropout Regulator (LDO), but various types of voltage regulators may be provided without being limited thereto.

The data processing unit debugger (396) is a component for debugging, analyzing, and modifying the program state of the data processing unit (393). For example, the data processing unit debugger (396) may be an MCU debugger, but is not limited thereto and may be provided in various ways.

In addition, the sensing substrate (300) can be connected to an external apparatus such as a power supply, a display apparatus, or a computing apparatus through an external connection portion (401) of the sensing substrate support (400). For example, 5V, 0.8 W of power can be supplied to the sensing substrate (300) through an external power supply.

Additionally, a CAN/PW connector (397) may be further configured on the substrate (310). In this case, a CAN communication signal can be transmitted from the communication unit (391) to an external apparatus through the CAN/PW connector (397), and at the same time, power can be supplied to the sensing substrate (300) from an external power supply.

Additionally, an inertial measurement unit may be further configured on the substrate (310). The inertial measurement unit is a module that measures 3-axis acceleration and angular velocity, and can provide position and movement data of the 6-axis force-torque sensing apparatus (1) in real time.

The measurement data of the inertial measurement unit can be transmitted to the data processing unit (393) and incorporated into the calculation of the 6-axis force-torque measurement accuracy, thereby improving the accuracy of measuring the magnitude and direction of an external force, especially in a dynamic environment.

Additionally, the temperature compensation function of the inertial measurement unit is incorporated into the 3-axis acceleration and angular velocity measurements, which can reduce measurement errors due to temperature changes. For this purpose, the temperature value measured by the temperature sensor (394) may be designed to be transmitted to the inertial measurement unit.

An example of an inertial measurement unit is an Inertial Measurement Unit (IMU) that includes an accelerometer (not shown) and a gyroscope (not shown), but various types of inertial measurement units may be used without being limited thereto.

Additionally, although not shown in the drawings, the 6-axis force-torque measuring apparatus (1) may be configured to include a battery apparatus. In this case, the sensing substrate (300) is connected to the battery apparatus and can be driven without external power. For example, a battery apparatus may be accommodated in the accommodating space (s) of the sensing substrate support (400) to supply power of 5V, 0.8 W to the sensing substrate (300).

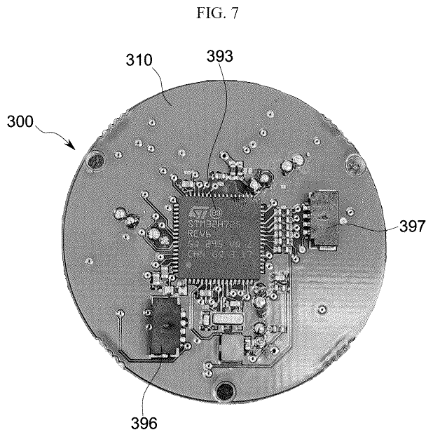

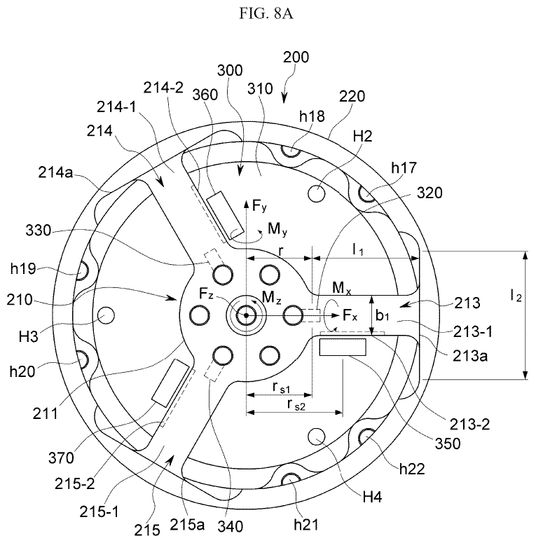

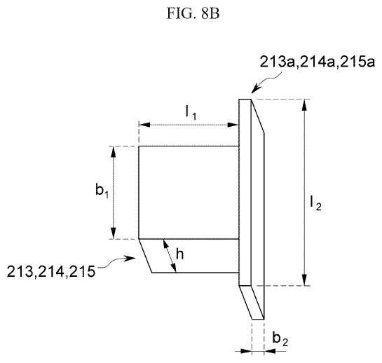

Hereinafter, a method for calculating the direction and magnitude of an external force using a 6-axis force-torque sensing apparatus (1) according to the first embodiment of the present disclosure will be described with reference to FIGS. 8 to 13. Here, the described calculation method and formulas can be included in a data processing process that calculates the direction and magnitude of an external force based on an electrical signal corresponding to the intensity of light collected through a light-receiving element of a photocoupler (320, 330, 340, 350, 360, 370) in a data processing apparatus (393).

FIG. 8A is a top-down view of a configuration in which a deformable structure (200), having three beam portions (213, 214, 215) formed at 120-degree intervals on a spring structure (210), is disposed above a sensing substrate (300), as described in FIG. 4. In addition, FIG. 8B shows a perspective view for explaining the length setting of the beam portions (213, 214, 215) and the support portions (213a, 214a, 215a).

Referring to FIG. 8A, with respect to the center of the spring structure (210), the longitudinal direction of the first beam portion (213) can be set as the x-axis, and the direction orthogonal to the x-axis in the plane between the first beam portion (213) and the second beam portion (214) can be set as the y-axis. Additionally, the upward direction of the spring structure (210), which is orthogonal to the x-axis and y-axis, i.e., the direction emerging from the plane of the drawing, can be set as the z-axis.

According to the x-axis, y-axis, and z-axis direction settings as described above, the x-axis component x, y-axis component F_{y}, and z-axis component F_{z} of the external force can be set. Additionally, an x-axis-based rotational moment Mₓ, a y-axis-based rotational moment M_{y}, and a z-axis-based rotational moment M_{z} caused by an external force can be set.

The x-axis component Fₓ, y-axis component F_{y}, and z-axis component F_{z} of the external force, set as described above, and the x-axis-based rotational moment Mₓ, y-axis-based rotational moment M_{y}, and z-axis-based rotational moment M_{z} generated by the external force can be measured as shown in Table 1 below through the first vertical displacement photocoupler (320), the first horizontal displacement photocoupler (350), the second vertical displacement photocoupler (330), the second horizontal displacement photocoupler (360), the third vertical displacement photocoupler (340), and the third horizontal displacement photocoupler (370), respectively.

TABLE 1

| | First | First | Second | Second | Third | Third |
|---|---|---|---|---|---|---|
| | vertical | horizontal | vertical | horizontal | vertical | horizontal |
| | displacement | displacement | displacement | displacement | displacement | displacement |
| | photocoupler | photocoupler | photocoupler | photocoupler | photocoupler | photocoupler |
| | (320) | (350) | (330) | (360) | (340) | (370) |
| Fₓ | ~ | ~ | ~ | + + | ~ | − − |
| F_{y} | ~ | + + | ~ | − | ~ | + |
| F_{z} | − | ~ | − | ~ | − | ~ |
| Mₓ | ~ | ~ | + + | ~ | − − | ~ |
| M_{y} | + + | ~ | − | − | ~ | ~ |
| M_{z} | ~ | + | ~ | + | ~ | + |

Here, the plus (+) symbol means that a positive displacement is calculated as the distance between each photocoupler (320, 330, 340, 350, 360, 370) and the spring structure (210) increases from the vertical reference gap (D) or the horizontal reference gap (d) due to an external force. Also, the minus (−) symbol means a case in which a negative displacement is calculated as the distance between each photocoupler (320, 330, 340, 350, 360, 370) and the spring structure (210) decreases from the vertical reference gap (D) or the horizontal reference gap (d) due to an external force.

In addition, the double plus (++) symbol means that a positive displacement with a large absolute value is calculated compared to the case of the plus (+) symbol as the distance between each photocoupler (320, 330, 340, 350, 360, 370) and the spring structure (210) greatly increases from the vertical reference gap (D) or the horizontal reference gap (d) due to an external force. In addition, the minus minus (−−) symbol means a case in which a negative displacement having a large absolute value is produced compared to the case of the minus (−) symbol as the distance between each photocoupler (320, 330, 340, 350, 360, 370) and the spring structure (210) is greatly reduced from the vertical reference distance (D) or the horizontal reference distance (d) due to an external force.

In addition, the tilde (˜) symbol means that the distance between each photocoupler (320, 330, 340, 350, 360, 370) and the spring structure (210) is maintained within a predetermined error range based on the vertical reference gap (D) or the horizontal reference gap (d), and thus no significant displacement is calculated.

For example, when an external force in the x-axis direction is applied, the spring structure (210) is deformed along the x-axis, and accordingly, the distance between the second horizontal displacement photocoupler (360) and the second horizontal displacement portion (214-2), as measured by the second horizontal displacement photocoupler (360), is greatly increased from the horizontal reference gap (d), so that a large positive displacement can be calculated. Additionally, the measured distance between the third horizontal displacement photocoupler (370) and the third horizontal displacement portion (215-2), as measured by the third horizontal displacement photocoupler (370), is greatly decreased from the horizontal reference gap (d).

As another example, when an external force in the z-axis direction is applied, the spring structure (210) is deformed along the z-axis, and accordingly, the measured distance between the first vertical displacement photocoupler (320) and the first vertical displacement portion (213-1), as measured by the first vertical displacement photocoupler (320), slightly decreases from the vertical reference gap (D). Likewise, the measured distance between the second vertical displacement photocoupler (330) and the second vertical displacement portion (214-1), as measured by the second vertical displacement photocoupler (330), and the measured distance between the third vertical displacement photocoupler (340) and the third vertical displacement portion (215-1), as measured by the third vertical displacement photocoupler (340), also slightly decrease from the vertical reference gap (D).

As shown in Table 1 above, for the x-axis component Fₓ, y-axis component F_{y}, and z-axis component F_{z} of the external force, and the x-axis-based rotational moment Mₓ, y-axis-based rotational moment M_{y}, and z-axis-based rotational moment M_{z} generated by the external force, the displacement of the spring structure (210) measured through the first vertical displacement photocoupler (320), the first horizontal displacement photocoupler (350), the second vertical displacement photocoupler (330), the second horizontal displacement photocoupler (360), the third vertical displacement photocoupler (340), and the third horizontal displacement photocoupler (370) can be expressed in the form of a 6×6 matrix. The 6×6 matrix calculated as above is called the Sensor Response Matrix, and the magnitude and direction of the external force can be calculated from this.

In addition, based on the sensor response matrix, a Calibration Matrix G representing the conversion relationship between the x-axis component Fₓ, the y-axis component F_{y}, the z-axis component F_{z} of the external force, the x-axis-based rotational moment Mₓ, the y-axis-based rotational moment M_{y}, and the z-axis-based rotational moment M_{z} generated by the external force, and the output signals of the first vertical displacement photocoupler (320), the first horizontal displacement photocoupler (350), the second vertical displacement photocoupler (330), the second horizontal displacement photocoupler (360), the third vertical displacement photocoupler (340), and the third horizontal displacement photocoupler (370) can be derived.

The calibration matrix G is a core mathematical model of the 6-axis force-torque sensor and connects the physical external force (F) applied to the spring structure (210) and the voltage (V) output from the photocouplers (320, 330, 340, 350, 360, 370), as shown in Equations 1 and 2.

$$Δ F = G Δ V \qquad [ Equation 1 ]$$

$$\frac{Δ F}{Δ V} = G \qquad Equation 2 )$$

Here, ΔF is the change in external force, and ΔV is the change in voltage output from the photocouplers (320, 330, 340, 350, 360, 370).

In addition, according to Equations 1 and 2, the larger the calibration matrix G value, the higher the sensitivity of the photocoupler (320, 330, 340, 350, 360, 370) in response to external force. That is, the larger the calibration matrix G value, the more sensitively it responds to external force, allowing even small changes in external force to be measured precisely.

Additionally, the smaller the Condition Number Con(G) of the calibration matrix G, the better the numerical stability of the calibration matrix G. Here, the Condition Number Con(G) of the matrix G can be adjusted by adjusting the geometric design and physical characteristics of the spring structure (210). For example, the geometric design of the spring structure (210) can be adjusted by adjusting the length (l₁) of the beam portions (213, 214, 215) and the length (l₂) of the support portions (213a, 214a, 215a) where the beam portions (213, 214, 215) are coupled to and supported by the frame structure (220). Additionally, the physical properties can be adjusted by adjusting the elastic modulus and shear modulus of the spring structure (210).

Therefore, by maximizing the calibration matrix G and minimizing the condition number Con(G) of the calibration matrix G, thereby minimizing the value Con(G)/|G|, a 6-axis force torque sensing apparatus with high sensitivity and stability can be provided.

In addition, referring to FIGS. 8A and 8B, the displacement Δd₁ of the first vertical displacement portion (213-1), the displacement Δd₂ of the second vertical displacement portion (214-1), the displacement Δd₃ of the third vertical displacement portion (215-1), the displacement Δd₄ of the first horizontal displacement portion (213-2), the displacement Δd₅ of the second horizontal displacement portion (214-2), and the displacement Δd₆ of the third horizontal displacement portion (215-2) can be calculated as in Equations 3 to 8 below.

$$Δ {d}_{1} = - {F}_{z} / {k}_{dFzv} - {M}_{x} {r}_{s 1} / {k}_{rMxv} \qquad Equation 3 )$$

$$Δ {d}_{2} = - {F}_{z} / {k}_{dFzv} - {M}_{x} {r}_{s 1} sin ( π / 3 ) / {k}_{rMxv} + {M}_{y} {r}_{s 1} sin ( π / 6 ) / {k}_{rMxv} \qquad Equation 4 )$$

$$Δ {d}_{3} = - {F}_{z} / {k}_{dFzv} + {M}_{x} {r}_{s 1} sin ( π / 3 ) / {k}_{rMxv} + {M}_{y} {r}_{s 1} sin ( π / 6 ) / {k}_{rMxv} \qquad Equation 5 )$$

$$Δ {d}_{4} = {F}_{y} / {k}_{dFyh} + {M}_{x} ( h / 2 - c ) / {k}_{rMxh} + {M}_{z} / {k}_{dMzh} \qquad Equation 6 )$$

$$Δ {d}_{5} = - {F}_{x} sin ( π / 3 ) / {k}_{dFyh} - {F}_{y} sin ( π / 6 ) / {k}_{dFyh} - {M}_{x} ( h / 2 - c ) sin ( π / 6 ) / {k}_{rMxh} - {M}_{y} ( h / 2 - c ) sin ( π / 3 ) / {k}_{rMxh} + {M}_{z} / {k}_{dMzh} \qquad Equation 7 )$$

$$Δ {d}_{6} = {F}_{x} sin ( π / 3 ) / {k}_{dFyh} - {F}_{y} sin ( π / 6 ) / {k}_{dFyh} + {M}_{x} ( h / 2 - c ) sin ( π / 6 ) / {k}_{rMxh} + {M}_{y} ( h / 2 - c ) sin ( π / 3 ) / {k}_{rMxh} + {M}_{z} / {k}_{dMzh} \qquad Equation 8 )$$

Here, K_{dFzv} is the position radius of the vertical displacement photocouplers (320, 330, 340), which is the horizontal distance from the center of the spring structure (210) to the vertical displacement photocouplers (320, 330, 340). Specifically, rₛ₁ may be the horizontal distance from the center of the spring structure (210) to the center point between the light-emitting element (321, 331, 341) and the light-receiving element (322, 332, 342) of the vertical displacement photocouplers (320, 330, 340). According to this setting, the vertical displacement (Δd₁, Δd₂, Δd₃) of the vertical displacement portions (213-1, 214-1, 215-1) located at a distance rₛ₁ from the center of the spring structure (210) can be measured through the vertical displacement photocouplers (320, 330, 340).

Additionally, rₛ₂ is the position radius of the horizontal displacement photocouplers (350, 360, 370), which is the horizontal distance from the center of the spring structure (210) to the horizontal displacement photocouplers (350, 360, 370). Specifically, rₛ₂ may be the distance from the center of the spring structure (210) to the center point between the light-emitting element (351, 361, 371) and the light-receiving element (352, 362, 372) of the horizontal displacement photocouplers (350, 360, 370). According to this setting, the horizontal displacement (Δd₄, Δd₅, Δd₆) of the horizontal displacement portions (213-2, 214-2, 215-2) located at a distance rₛ₂ from the center of the spring structure (210) can be measured through the horizontal displacement photocouplers (350, 360, 370).

Additionally, h is the vertical length of the horizontal displacement portions (213-2, 214-2, 215-2). For example, when the beam portions (213, 214, 215) and support portions (213a, 214a, 215a) of the spring structure (210) are formed to have a constant thickness in the vertical direction, h may be a numerical value indicating the vertical thickness of the spring structure (210). Here, the vertical thickness h of the spring structure (210) is a value excluding the vertical length of the horizontal displacement portions (213-2, 214-2, 215-2).

Additionally, c is the vertical distance from the substrate (310) to the horizontal displacement photocouplers (350, 360, 370). Specifically, c may be the distance from the substrate (310) to the vertical center point of the light-emitting element (351, 361, 371) and the light-receiving element (352, 362, 372) of the horizontal displacement photocouplers (350, 360, 370). For example, horizontal displacement portions (213-2, 214-2, 215-2) with h of 6 mm may be provided, and horizontal displacement photocouplers (350, 360, 370) may be provided such that c is 0.04 mm.

In addition, h/2-c represents the vertical offset distance between the vertical center of the horizontal displacement portions (213-2, 214-2, 215-2) and the vertical center of the horizontal displacement photocouplers (350, 360, 370), and is a value for mathematically correcting the positional deviation between the horizontal displacement portions (213-2, 214-2, 215-2) and the horizontal displacement photocouplers (350, 360, 370) to minimize measurement error.

Additionally, k_{rMxv} may be a torsional spring constant of the vertical displacement portions (213-1, 214-1, 215-1) due to x-axis and y-axis rotational moments at the position radius rₛ₁ of the vertical displacement photocouplers (320, 330, 340). Additionally, K_{dFzv} may be a spring constant corresponding to the z-axis deformation of the vertical displacement portions (213-1, 214-1, 215-1) at the position radius rₛ₁ of the vertical displacement photocouplers (320, 330, 340).

Additionally, K_{rMxh} may be a spring constant corresponding to the deformation of the horizontal displacement portion (213-2, 214-2, 215-2) due to the x-axis and y-axis rotational moments at the position radius rₛ₂₀f the horizontal displacement photocoupler (350, 360, 370). Additionally, K_{dFyh} may be a spring constant corresponding to the deformation of the horizontal displacement portions (213-2, 214-2, 215-2) due to x-axis and y-axis rotational moments at the position radius rₛ₂ of the horizontal displacement photocouplers (350, 360, 370). Additionally, K_{rMzh} may be a spring constant corresponding to the deformation of the horizontal displacement portions (213-2, 214-2, 215-2) caused by the force in the y-axis direction at the position radius rₛ₂ of the horizontal displacement photocouplers (350, 360, 370).

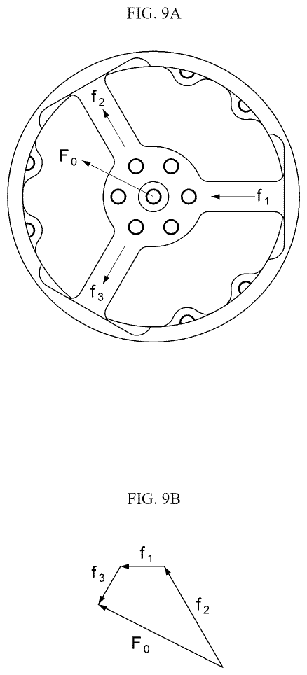

In addition, FIG. 9A illustrates an embodiment of a first beam portion deformation force (f₁), which is a deformation force acting on a first beam portion (213) of a spring structure (210) by an external force; a second beam portion deformation force (f₂), which is a deformation force acting on a second beam portion (214); and a third beam portion deformation force (f₃), which is a deformation force acting on a third beam portion (215). Additionally, the total deformation force (F₀) of the spring structure (210), which is the sum of the first beam portion deformation force (f₁), the second beam portion deformation force (f₂), and the third beam portion deformation force (f₃), is shown. FIG. 9B illustrates a vector composition diagram in which the first beam portion deformation force (f₁), the second beam portion deformation force (f₂), and the third beam portion deformation force (f₃) are vectorially combined to form a total deformation force (F₀). The total deformation force (F₀) represents the overall response of the spring structure (210) to the external force.

In this regard, the following Equation 9 shows a method for calculating the total displacement Δd_{F}_{₀} of the spring structure (210) due to the total deformation force (F₀).

$$Δ {d}_{{F}_{C}} = Δ {d}_{{f}_{1}} + Δ {d}_{{f}_{2}} + Δ {d}_{{f}_{3}} = {k}_{0} {f}_{1} + {k}_{0} {f}_{2} + {k}_{0} {f}_{3} = {k}_{0} ( {f}_{1} + {f}_{2} + {f}_{3} ) = {k}_{0} {F}_{0} \qquad Equation 9 )$$

Here, Δd_{f}_{₁} is the displacement due to the first beam portion deformation force (f₁), Δd_{f}_{₂} is the displacement due to the second beam portion deformation force (f₂), and Δd_{f}_{₁} is the displacement due to the third beam portion deformation force (f₃). Additionally, k₀ is a spring Stiffness Coefficient determined according to the material and geometric characteristics of the spring structure (210).

Referring to FIG. 9A, FIG. 9B and Equation 9, the spring structure (210) has the same spring stiffness in the x-axis and y-axis directions due to isotropy, which can simplify calculations. That is, by calculating the linear spring stiffness and torsional spring stiffness of the x-axis, the linear spring stiffness and torsional spring stiffness of the y-axis can be obtained. Accordingly, it is sufficient to calculate the spring stiffness of four axes—i.e., the linear and torsional spring stiffness of the x-axis or y-axis, and the linear and torsional spring stiffness of the z-axis-without having to calculate the spring stiffness of all 6 axes. In particular, the linear stiffness coefficients of the x-axis and y-axis can be expressed as a single constant k₀, which can further simplify the calculation.

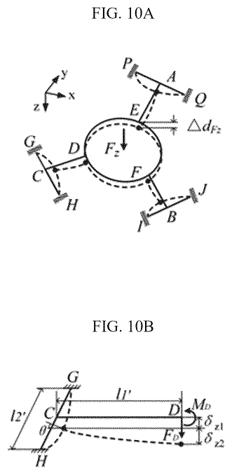

Hereinafter, a method for obtaining the linear spring stiffness coefficient k_{F}_{_{z}} in the z-axis direction due to the z-axis component F_{z} of the external force is described with reference to FIGS. 10A and 10B.

FIGS. 10A and 10B are diagrams schematically showing that a vertical displacement Δd_{F}_{_{z}} of a spring structure (210) occurs due to the z-axis component F_{z} of an external force.

In FIG. 10A, a circular figure representing the central portion (212) of the spring structure (210); lines EA, DC, and FB representing beam portions (213, 214, 215) connected from the central portion (212) of the spring structure (210) to support portions (213a, 214a, 215a); and lines PQ, HG, and JI representing the support portions (213a, 214a, 215a) are shown. Here, points E, D, and F are connection points between the central portion (212) and each beam portion (213, 214, 215); points A, C, and B are connection points between each beam portion (213, 214, 215) and each support portion (213a, 214a, 215a); and points Q, G, and I are fixed points whose positions are fixed as each support portion (213a, 214a, 215a) is coupled to the frame structure (220). Hereinafter, in this specification, line EA, line DC, and line FB are referred to as beam portion EA, beam portion DC, and beam portion FB, respectively, and line PQ, line HG, and line JI are referred to as support portion PQ, support portion HG, and support portion JI, respectively. In addition, FIG. 10A shows the z-axis component F_{z} of the external force applied to the spring structure (210) and the corresponding vertical displacement Δd_{F}_{_{z}} of the spring structure (210).

FIG. 10B shows an embodiment in which a vertical force F_{D} and a rotational moment M_{D} are applied to point D by the z-axis component F_{z} of an external force. In this case, point D moves vertically downward, the beam portion DC tilts downward toward the central portion (212), the support portion HG bends vertically downward, and point C moves downward toward the central portion (212). Additionally, rotational deformation occurs in the support portion HG and the beam portion DC, so that the beam portion DC can tilt downward by a predetermined angle $\theta$ with respect to point C.

Accordingly, the vertical displacement Δd_{F}_{_{z}} of the spring structure (210) caused by the vertical force F_{D} applied to point D can be calculated as in Equation 10 below.

$$Δ {d}_{{F}_{z}} = {δ}_{z 1} + {δ}_{z 2} + θ {l}_{1}^{′} \qquad Equation 10 )$$

Here, δ_{z1} is the displacement caused by the vertical force F_{D}, and

$${δ}_{z 2} + θ {l}_{1}^{′}$$

is the displacement caused by the rotational moment M_{D}. In addition, l′₁ is the distance from the rotation center C of the beam portion DC to the displacement point D, which is the effective rotational distance of the beam portion DC, and can be the sum of the length l₁ of the beam portion and the horizontal thickness b₂ of the support portion. Here, the horizontal thickness b₂₀f the support portion can be confirmed with reference to FIG. 8B.

Additionally, δ_{z1}, δ_{z2}, and the inclination angle θ of the beam portion DC can be calculated as in Equations 11 to 13 below.

$$θ = ( {F}_{D} {l}_{1}^{′} - {M}_{D} ) {l}_{2}^{′} / ( 4 {GI}_{1} ) \qquad Equation 11 )$$

$${δ}_{z 1} = \frac{{F}_{D} {I}_{2}^{′3}}{192 {EI}_{22}} + \frac{{F}_{D} {l}_{2}^{′}}{4 {kGS}_{2}} \qquad Equation 12 )$$

$${δ}_{z 2} = \frac{{F}_{D} {I}_{1}^{′3}}{3 {EI}_{12}} - \frac{{M}_{D} {l}_{2}^{′}}{2 {EI}_{12}} + \frac{{F}_{D} {l}_{1}^{′}}{{kGS}_{1}} \qquad Equation 13 )$$

Here, l′₂ is the distance between the fixed points G and H at both ends of the support portion GH, and can be a value obtained by subtracting the horizontal thickness b₁ of the beam portion from the length l₂ of the support portion.

Additionally, E is the Elastic Modulus of the spring structure (210), and G is the Shear Modulus.

In addition, S₁ denotes the cross-sectional area b₁ h of the beam portion, S₂ denotes the cross-sectional area b₂ h of the support portion, and k is the Shear Coefficient calculated as 10/(12+b₂h).

Additionally, I₁₂ is the z-axis second moment of area (Moment of Inertia) of the beam portion, calculated as b₁ h³/12, and I₂₂ is the z-axis second moment of area (Moment of Inertia) of the support portion, calculated as b₂ h³/12.

In addition, according to the z-axis component F_{z} of the external force, the vertical force F_{D} applied to point D, the vertical force F_{E} applied to point E, and the vertical force F_{F} applied to point F are identical due to the symmetry of the spring structure (210). Accordingly, the z-axis component F_{z} of the external force can be calculated as shown in Equation 14 below.

$${F}_{z} = {F}_{E} + {F}_{D} + {F}_{F} = 3 {F}_{D} , {F}_{E} = {F}_{D} = {F}_{F} \qquad Equation 14 )$$

Accordingly, the vertical displacements of points D, E, and F due to the z-axis component F_{z} of the external force all occur identically as Δd_{F}_{_{z}}. That is, the central portion of the spring structure (210) moves in the vertical direction without a change in inclination due to the z-axis component F_{z} of the external force, and accordingly, the inclination angles of points D, E, and F become 0. In this regard, the following Equation 15 shows a conditional expression in which the inclination angle θ_{D} of point D due to the vertical force F_{D} is 0. In addition, the conditional expression of Equation 15 is applied in the same manner to the inclination angle θ_{E} of point E due to the vertical force F_{E} and the inclination angle θ_{F} of point F due to the vertical force F_{F}.

$${θ}_{D} = \frac{{F}_{D} {l}_{1}^{′2}}{2 {EI}_{12}} - \frac{{M}_{D} {l}_{1}^{′}}{{EI}_{12}} + \frac{( {F}_{D} {l}_{1}^{′} - {M}_{D} ) {l}_{2}^{′}}{4 {GI}_{t}} = 0 \qquad Equation 15 )$$

In addition, the relationship between the z-axis component F_{z} of the external force and the corresponding vertical displacement Δd_{F}_{_{z}} at point D can be defined as in Equation 16 below.

$$Δ {d}_{{F}_{z}} = {k}_{{F}_{z}} {F}_{z} \qquad Equation 16 )$$

In addition, the displacement distribution function

$${δ}_{{F}_{z}} ( x )$$

in the x-axis direction due to the z-axis component F_{z} of the external force can be defined as in Equation 17 below.

$${δ}_{{F}_{z}} ( x ) = {F}_{D} ( \text{} \frac{{X}^{2} ( 3 {l}_{1}^{′} - x )}{6 {EI}_{12}} - \frac{{a}_{1} {x}^{2}}{2 {EI}_{12}} + \frac{( {l}_{1}^{′} - {a}_{1} ) {l}_{2}^{′}}{4 {GI}_{t}} + \frac{{l}_{2}^{′3}}{192 {EI}_{22}} + \frac{4 {l}_{1}^{′} {S}_{2} + {l}_{2}^{′} {S}_{1}}{4 {kGS}_{1} {S}_{2}} \qquad Equation 17 )$$

Here, if

$$x = {l}_{1}^{′} , {δ}_{{F}_{z}} ( x )$$

becomes Δd_{F}_{_{z}}, and since F_{D}=F_{z}/3, Equation 18 below can be derived through Equations 16 and 17.

$${k}_{{F}_{z}} = \frac{1}{3} ( \frac{{l}_{1}^{′3}}{3 {EI}_{12}} - \frac{{a}_{1} {l}_{1}^{′2}}{2 {EI}_{12}} + \frac{( {l}_{1}^{′} - {a}_{1} ) {l}_{1}^{′} {l}_{2}^{′}}{4 {GI}_{t}} + \frac{{l}_{2}^{′3}}{192 {EI}_{22}} + \frac{4 {l}_{1}^{′} {S}_{2} + {l}_{2}^{′} {S}_{1}}{4 {kGS}_{2}} ) \qquad Equation 18 )$$

Here, k_{F}_{_{z}} is the reciprocal of the spring constant of the spring structure (210), which is the spring stiffness coefficient in the z-axis direction.

In addition, a₁ is the effective distance from point D to the axis of the rotational moment M_{D}, and the relationship between the vertical force F_{D} at point D due to the z-axis component F_{z} of the external force and the rotational moment M_{D} satisfies M_{D}=a₁*F_{D}. Here, a₁ can be defined as

$${a}_{1} = \frac{{l}_{1}^{′} ( 2 {l}_{1}^{′} {GI}_{t} + {l}_{2}^{′} {EI}_{12 )}}{4 {l}_{1}^{′} {GI}_{t} + {l}_{2}^{′} {EI}_{12}} .$$

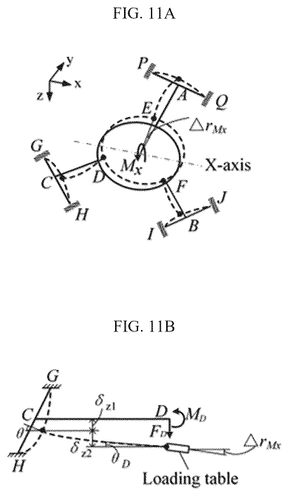

Hereinafter, a method for obtaining the torsional spring stiffness coefficient k_{M}_{ₓ} with respect to the x-axis based on the x-axis rotational moment Mₓ of an external force will be described with reference to FIGS. 11A and 111B.

FIGS. 11A and 11B are diagrams schematically illustrating that a torsional response, i.e., a rotational angular displacement w^{x}, occurs in the spring structure (210) due to a rotational moment Mx.

Referring to FIGS. 11A and 111B, the rotational angular displacement Δr_{Mx} can be calculated as in Equation 19 below.

$$Δ {r}_{Mx} = Δ {r}_{{E}_{Mx}} = 2 Δ {r}_{{D}_{Mx}} \qquad Equation 19 )$$

Here, Δr_{E}_{_{Mx}} is the rotational angular displacement by which point E rotates about the x-axis due to the rotational moment Mₓ, and Δr_{D}_{_{Mx}} is the rotational angular displacement by which point D rotates about the x-axis due to the rotational moment Mₓ.

In addition, by using the rotational angular displacement Δr_{D}_{_{Mx}} of point D and the radius r of the center portion (212) of the spring structure (210), the linear displacement Δd_{D}_{_{Mx}} of point D due to the rotational moment Mₓ can be calculated as in Equation 20 below. Here, the radius r of the central portion (212) of the spring structure (210) can be confirmed with reference to FIG. 8A.

$$Δ {r}_{{D}_{Mx}} = Δ {d}_{{D}_{Mx}} lr \qquad Equation 20 )$$

Also, as in the case of the z-axis component F_{z} of the external force, a vertical force F_{D} and a rotational moment M_{D} are applied to point D by the rotational moment Mₓ, and the linear displacement Δd_{D}_{_{Mx}} of point D by the rotational moment Mₓ can be calculated in the same manner as Δd_{F}_{_{z}}. In this regard, Equation 21 below shows a calculation formula for obtaining the linear displacement Δd_{D}_{_{Mx}} of point D due to the rotational moment Mₓ, and Equation 22 below shows a calculation formula for obtaining the inclination angle θ_{D} of point D due to the rotational moment Mₓ.

$$Δ {d}_{{D}_{Mx}} = {δ}_{z 1} + {δ}_{z 2} + θ {l}_{1}^{′} \qquad Equation 21 )$$

$${θ}_{D} = \frac{{F}_{D} {l}_{1}^{′2}}{2 {EI}_{12}} - \frac{{M}_{D} {l}_{1}^{′}}{{EI}_{12}} + \frac{( {F}_{D} {l}_{1}^{′} - {M}_{D} ) {l}_{2}^{′}}{4 {GI}_{t}} = - Δ {r}_{{D}_{Mx}} \qquad Equation 22 )$$

In addition, the relationship between the vertical force F_{D} applied to point D by the rotational moment Mₓ and the rotational moment M_{D} can be defined as in Equation 23 below, and the relationship between the vertical force F_{E} applied to point E by the rotational moment Mₓ and the rotational moment M_{E} can be defined as in Equation 24 below.

$${F}_{D} {A}_{1} = {M}_{D} {B}_{1} \qquad Equation 23 )$$

$${F}_{E} {A}_{1} = {M}_{E} {B}_{1} \qquad Equation 24 )$$

Here,

$${A}_{1} = ( \frac{{l}_{1}^{′2}}{3 {EI}_{12}} + \frac{{l}_{1}^{′} {l}_{2}^{′}}{4 {GI}_{t}} + \frac{1}{( {kGS}_{1} )} ) {λ}_{1} + ( \frac{1}{4 {kGS}_{2}} + \frac{{l}_{2}^{′2}}{192 {EI}_{22}} ) {λ}_{2} + ( \frac{{l}_{1}^{′2}}{2 {EI}_{12}} + \frac{{l}_{1}^{′} {l}_{2}^{′}}{4 {GI}_{t}} ) ,$$

$${B}_{1} = ( \frac{{l}_{1}^{′}}{2 {EI}_{12}} + \frac{{l}_{2}^{′}}{4 {GI}_{t}} ) {λ}_{1} + ( \frac{{l}_{1}^{′}}{2 {EI}_{12}} + \frac{{l}_{2}^{′}}{4 {GI}_{t}} ) ,$$

$${λ}_{1} = {l}_{1}^{′} / r , and {λ}_{2} = {l}_{2}^{′} / r ,$$

In addition, through static equilibrium, the relationship between the vertical force F_{E} applied to point E by the rotational moment Mₓ and the vertical force F_{D} applied to point D is defined as in Equation 25 below, and the rotational moment Mₓ can be defined as in Equation 26 below.

$${F}_{E} = 2 {F}_{D} \qquad Equation 25 )$$

$${M}_{x} = {M}_{E} + {F}_{E} r + 2 ( {M}_{D} + {F}_{D} r ) sin 30 ° \qquad Equation 26 )$$

In addition, the relationship between the rotational angular displacements Δr_{Mx} due to the rotational moment Mₓ can be defined as in Equation 27 below.

$$Δ {r}_{Mx} = {k}_{{M}_{x}} {M}_{x} \qquad Equation 27 )$$

Additionally, the displacement distribution function δ_{M}_{ₓ}(x) in the x-axis direction due to the rotational moment Mₓ can be defined as in Equation 28 below.

$${δ}_{M} \text{?} ( x ) = \frac{{M}_{x}}{3 ( {A}_{1} / {B}_{1} + r )} ( \frac{{l}_{2}^{′3}}{192 {EI}_{22}} + \frac{{l}_{2}^{′}}{4 {kGS}_{2}} + \frac{x}{{kGS}_{1}} + \frac{{x}^{2} ( 3 {l}_{1}^{′} - x )}{6 {EI}_{12}} - \frac{{x}^{2}}{2 {EI}_{12}} + \frac{( {l}_{1}^{′} - {A}_{1} / {B}_{1} ) {l}_{2}^{′}}{4 GI \text{?}} x ) \qquad Equation 28 )$$

$$\text{?} \text{indicates text missing or illegible when filed}$$

Here, if x=l′₁, δMₓ(x) becomes Δr_{Mx}, and Equation 29 can be derived through Equations 27 and 28.

$${k}_{M} \text{?} = \frac{2}{3 ( {A}_{1} / {B}_{1} + r )} ( \frac{{l}_{2}^{′3}}{192 {EI}_{22}} + \frac{{l}_{2}^{′}}{4 {kGS}_{2}} + \frac{2 {l}_{1}^{′3} - 3 {A}_{1} / {B}_{1} {l}_{1}^{′2}}{6 {EI}_{12}} - \frac{{l}_{1}^{′}}{{kGS}_{1}} + \frac{( {l}_{1}^{′} - {A}_{1} / {B}_{1} ) {l}_{1}^{′} {l}_{2}^{′}}{4 GI \text{?}} ) \qquad Equation 29 )$$

$$\text{?} \text{indicates text missing or illegible when filed}$$

Here, k_{Mx} is the torsional spring stiffness coefficient k_{Mx} due to the external force's rotational moment Mₓ with respect to the x-axis.

Meanwhile, in the same manner as above, calculation formulas for the y-axis directional force F_{y} and the Z-axis-based rotational moment M_{z} of the external force can also be derived, and accordingly, the response to F_{z}, Mₓ, F_{y}, and M_{z} applied at a position with a distance r from the center can be comprehensively modeled.

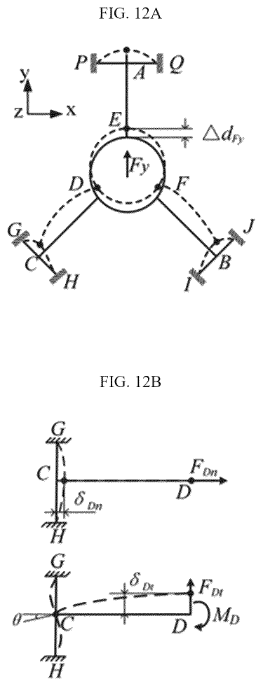

In this regard, FIGS. 12A and 12B are diagrams schematically showing that a vertical displacement Δd_{F}_{_{z}} occurs in the spring structure (210) due to an external force F_{y} in the y-axis direction. In addition, Equations 30 to 46 show a series of equations for obtaining the linear spring stiffness coefficient k_{F}_{_{z}} due to the force F_{y} in the y-axis direction of the external force of the spring structure (210).

$$θ = ( F \text{?} {l}_{1}^{′} - {M}_{D} ) {l}_{2}^{′} / ( 16 {EI}_{21} ) \qquad Equation 30 )$$

$${δ}_{Dt} = \frac{F \text{?} {I}_{1}^{′3}}{3 {EI}_{11}} - \frac{{M}_{D} {l}_{1}^{′2}}{2 {EI}_{11}} + \frac{{F}_{D} {l}_{1}^{′}}{{kGS}_{1}} + θ {l}_{1}^{′} \qquad Equation 31 )$$

$${δ}_{Dn} = \frac{F \text{?} {I}_{1}^{′3}}{192 {EI}_{11}} + \frac{{F}_{Dn} {l}_{1}^{′}}{{ES}_{1}} + \frac{{F}_{Dn} {l}_{2}^{′}}{4 {kGS}_{2}} \qquad Equation 32 )$$

$$Δ {d}_{E} = \frac{{F}_{E} {I}_{2}^{′3}}{192 {EI}_{21}} + \frac{{F}_{E} {l}_{2}^{′}}{{ES}_{2}} + \frac{{F}_{E} {l}_{2}^{′}}{4 {kGS}_{2}} \qquad Equation 33 )$$

$$Δ {d}_{E} = Δ {d}_{D} = \sqrt{{δ}_{Dn}^{2} + {δ}_{Dt}^{2}} \qquad Equation 34 )$$

$${θ}_{D} = \frac{F \text{?} {l}_{1}^{′2}}{2 {EI}_{11}} - \frac{{M}_{D} {l}_{1}^{′}}{{EI}_{11}} + \frac{( {F}_{D} \text{?} {l}_{1}^{′} - {M}_{D} ) {l}_{2}^{′}}{16 {EI}_{21}} = 0 \qquad Equation 35 )$$

$${δ}_{Dn} = tan 30 {°δ}_{Dt} \qquad Equation 36 )$$

$${F}_{y} = 2 ( F \text{?} sin 30 ° + F \text{?} cos 30 ° ) + {F}_{E} \qquad Equation 37 )$$

$${F}_{E} = {F}_{y} / {A}_{4} \qquad Equation 38 )$$

$${M}_{D} = {F}_{y} {A}_{2} {B}_{3} / ( 2 {A}_{3} {A}_{4} {B}_{2} ) \qquad Equation 39 )$$

$${F}_{Dn} = \frac{{F}_{y}}{2 {A}_{4}} \qquad Equation 40 )$$

$${F}_{Dt} = {F}_{y} {B}_{3} / ( 2 {A}_{3} {A}_{4} ) \qquad Equation 41 )$$

$${δ}_{Fy} ( x ) = \sqrt{{{δ}_{Dn}^{2} ( x )}^{2} + {{δ}_{Dt}^{2} ( x )}^{2} )} = {δ}_{Dt} ( x ) / cos 30 ° \qquad Equation 42 )$$

$${δ}_{Dn} ( x ) = \frac{{F}_{Dn} {I}_{2}^{′3}}{192 {EI}_{21}} + \frac{F \text{?} x}{{ES}_{1}} + \frac{{F}_{Dn} x}{4 {kGS}_{2}} \qquad Equation 43 )$$

$${δ}_{Dt} ( x ) = \frac{{F}_{Dt} {x}^{2} ( 3 {I}_{1}^{′} - x )}{6 {EI}_{11}} - \frac{{M}_{D} {x}^{2}}{2 {EI}_{11}} + \frac{( {F}_{Dt} {l}_{1}^{′} - {M}_{D} ) {I}_{2}^{′}}{16 {EI}_{21}} x + \frac{F \text{?} x}{4 {kGS}_{1}} ) \qquad Equation 44 )$$

$$Δ {d}_{{F}_{y}} = {k}_{{F}_{y}} {F}_{y} \qquad Equation 45 )$$

$${k}_{{F}_{y}} = \frac{{B}_{3}}{2 {A}_{3} {A}_{4} cos 30 °} ( \frac{{l}_{1}^{′3}}{3 {EI}_{11}} - \frac{{A}_{2} {l}_{1}^{′2}}{2 {EI}_{11} {B}_{2}} + \frac{{l}_{1}^{′} {l}_{2}^{′} - {A}_{2} {l}_{1}^{′} {l}_{2}^{′} / {B}_{2}}{16 {EI}_{12}} + \frac{{l}_{1}^{′}}{4 {kGS}_{1}} ) \qquad Equation 46 )$$

$$Here ,$$

$${A}_{2} = {l}_{1}^{′2} / ( 2 {I}_{11} ) + {l}_{1}^{′} {l}_{2}^{′} / ( 16 {I}_{21} ) ,$$

$${B}_{2} = {l}_{1}^{′2} / ( {I}_{11} ) + {l}_{2}^{′} / ( 16 {I}_{21} ) ,$$

$${A}_{3} = {l}_{1}^{′3} / ( 3 {EI}_{11} ) + {l}_{1}^{′} {l}_{2}^{′} / ( 16 {I}_{21} ) + {l}_{1}^{′} / ( {kGS}_{1} ) - {A}_{2} ( {l}_{1}^{′2} / ( 2 {EI}_{11} ) + {l}_{1}^{′} {l}_{2}^{′} / ( 16 {EI}_{21} ) ) / {B}_{2 ,}$$

$${B}_{3} = \sqrt{3} ( {l}_{2}^{′3} / ( 192 {EI}_{21} ) + {l}_{1}^{′} / ( {ES}_{1} ) + {l}_{2}^{′} / ( 4 {kGS}_{2} ) ) ,$$

$$and$$

$${A}_{4} = ( 3 / 2 + \sqrt{3} {B}_{3} / ( 2 {A}_{3} ) ) .$$

$$\text{?} \text{indicates text missing or illegible when filed}$$

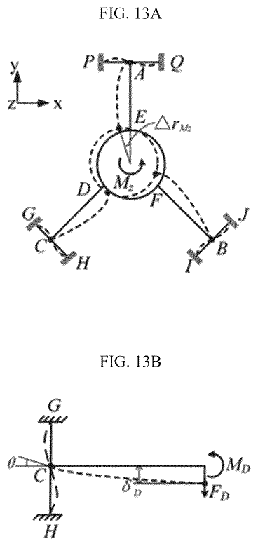

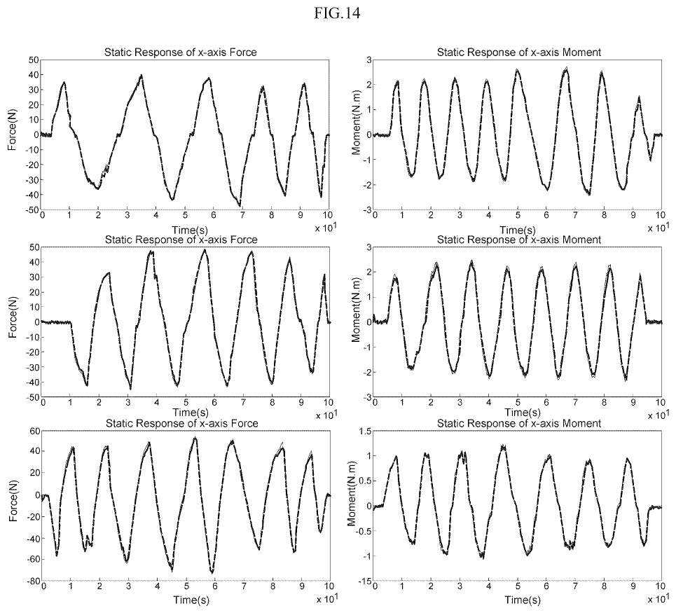

In addition, FIGS. 13A and 13B are diagrams schematically showing that a rotational angular displacement Δr_{M}_{_{z}} occurs in the spring structure (210) due to a rotational moment $Mz$ with respect to the z-axis of an external force. In this regard, Equations 47 to 55 show a series of equations for obtaining the torsional spring stiffness coefficient k_{M}_{_{z}} due to the rotational moment M_{z} with respect to the z-axis of the external force.

$$3 {F}_{D} r + 3 {M}_{D} = {M}_{z} \qquad Equation 47 )$$

$${θ}_{D} = \frac{{F}_{D} {l}_{1}^{′2}}{2 {EI}_{11}} - \frac{{M}_{D} {l}_{1}^{′}}{{EI}_{11}} + \frac{( {F}_{D} {l}_{1}^{′} - {M}_{D} ) {l}_{2}^{′}}{16 {EI}_{21}} = {δ}_{D} / r \qquad Equation 48 )$$

$${δ}_{D} = \frac{{F}_{D} {l}_{1}^{′3}}{3 {EI}_{11}} - \frac{{M}_{D} {l}_{1}^{′2}}{2 {EI}_{11}} + \frac{( {F}_{D} {l}_{1}^{′} - {M}_{D} ) {l}_{1}^{′} {l}_{2}^{′}}{16 {EI}_{21}} x + \frac{{F}_{D} {l}_{1}^{′}}{4 {kGS}_{1}} \qquad Equation 49 )$$

$${F}_{D} = {M}_{z} / ( 3 ( r + \frac{1}{{a}_{2}} ) ) \qquad Equation 50 )$$

$${M}_{D} = {M}_{z} / ( 3 ( {a}_{2} r + 1 ) ) \qquad Equation 51 )$$

$${a}_{2} = \frac{{l}_{1}^{′} / ( {EI}_{11} ) + {l}_{2}^{′} ( 16 {EI}_{21} ) + ( {l}_{1}^{′} / ( 2 {EI}_{11} ) + {l}_{2}^{′} / ( 16 {EI}_{21} ) ) {λ}_{1}}{\begin{matrix}{l}_{1}^{′2} / ( 2 {EI}_{11} ) + {l}_{1}^{′} {l}_{2}^{′} / ( 16 {EI}_{21} ) + ( {l}_{1}^{′2} / ( 3 {EI}_{11} ) + \\ {l}_{1}^{′} {l}_{2}^{′} / ( 16 {EI}_{21} ) + 1 / ( {kGS}_{1} ) ) {λ}_{1}\end{matrix}} \qquad Equation 52 )$$

$${δ}_{Mz} ( x ) = {F}_{D} ( \frac{{x}^{2}}{6 {EI}_{11}} ( - x + 3 {I}_{1}^{′} ) - \frac{{a}_{2} {x}^{2}}{2 {EI}_{11}} + \frac{( {l}_{1}^{′} - {a}_{2} ) {l}_{2}^{′}}{16 {EI}_{21}} x + \frac{x}{{kGS}_{1}} ) \qquad Equation 53 )$$

$${Δr}_{{M}_{z}} = {k}_{{M}_{z}} {M}_{z} \qquad Equation 54 )$$

$${k}_{{M}_{z}} = \frac{{B}_{3}}{3 ( r + 1 / {a}_{2} )} ( \frac{{l}_{1}^{′3}}{3 {EI}_{11}} - \frac{{l}_{1}^{′2} {a}_{2}}{2 {EI}_{11}} + \frac{{l}_{1}^{′2} {l}_{2}^{′} - {l}_{1}^{′} {l}_{2}^{′} {a}_{2}}{16 {EI}_{21}} + \frac{{l}_{1}^{′}}{{kGS}_{1}} ) \qquad Equation 55 )$$

Meanwhile, the relationship between the displacement Δd₁ of the first vertical displacement portion (213-1), the displacement Δd₂ of the second vertical displacement portion (214-1), the displacement Δd₃ of the third vertical displacement portion (215-1), the displacement Δd₄ of the first horizontal displacement portion (213-2), the displacement Δd₅ of the second horizontal displacement portion (214-2), and the displacement Δd₆ of the third horizontal displacement portion (215-2), calculated through Equations 3 to 8, and the x-axis component Fₓ, y-axis component F_{y}, and z-axis component F_{z} of the external force, and the x-axis-based rotational moment Mₓ, y-axis-based rotational moment M_{y}, and z-axis-based rotational moment M_{z} generated by the external force can be defined as in Equation 56 below.

$$Δ d = AF , \qquad Equation 56 )$$

$$A = [ \begin{matrix}0 & 0 & - \frac{1}{{k}_{dFzv}} & 0 & - \frac{{r}_{s 1}}{{k}_{rMxv}} & 0 \\ 0 & 0 & - \frac{1}{{k}_{dFzv}} & - \frac{{r}_{s 1} sin ( π / 3 )}{{k}_{rMxv}} & \frac{{r}_{s 1} sin ( π / 6 )}{{k}_{rMxv}} & 0 \\ 0 & 0 & - \frac{1}{{k}_{dFzv}} & \frac{{r}_{s 1} sin ( π / 3 )}{{k}_{rMxv}} & \frac{{r}_{s 1} sin ( π / 6 )}{{k}_{rMxv}} & 0 \\ 0 & \frac{1}{{k}_{dFyh}} & 0 & \frac{( h / 2 - c )}{{k}_{rMxh}} & 0 & \frac{1}{{k}_{dMzh}} \\ \frac{- sin ( π / 3 )}{{k}_{dFyh}} & \frac{- sin ( π / 6 )}{{k}_{dFyh}} & 0 & \frac{- ( h / 2 - c ) sin ( π / 6 )}{{k}_{rMxh}} & \frac{- ( h / 2 - c ) sin ( π / 3 )}{{k}_{rMxh}} & \frac{1}{{k}_{dMzh}} \\ \frac{sin ( π / 3 )}{{k}_{dFyh}} & \frac{- sin ( π / 6 )}{{k}_{dFyh}} & 0 & \frac{( h / 2 - c ) sin ( π / 6 )}{{k}_{rMxh}} & \frac{( h / 2 - c ) sin ( π / 3 )}{{k}_{rMxh}} & \frac{1}{{k}_{dMzh}}\end{matrix} ] ,$$

$$Δ d = [ \begin{matrix}Δ {d}_{1} \\ Δ {d}_{2} \\ Δ {d}_{3} \\ Δ {d}_{4} \\ Δ {d}_{5} \\ Δ {d}_{6}\end{matrix} ] , F = [ \begin{matrix}{F}_{x} \\ {F}_{y} \\ {F}_{z} \\ {M}_{x} \\ {M}_{y} \\ {M}_{z}\end{matrix} ]$$

Here, k_{rMxv} may be derived by applying the position radius rₛ₁ of the vertical displacement photocouplers (320, 330, 340) to the reciprocal of the x-axis-based torsional spring stiffness coefficient k_{M}_{ₓ} of the spring structure (210) due to the x-axis-based rotational moment Mₓ of the external force, as defined by Equation 29.

In addition, K_{dFzv} may be derived by applying the position radius rₛ₁ of the vertical displacement photocouplers (320, 330, 340) to the reciprocal of the z-axis linear spring stiffness coefficient k_{M}_{ₓ} of the spring structure (210) due to the z-axis component F_{z} of the external force, as defined by Equation 18.

Specifically, by defining a radius variable u using the position radius rₛ₁ of the vertical displacement photocouplers (320, 330, 340) as in Equation 57 below, and applying the radius variable u to the reciprocals of Equations 18, 29, 46, and 55, Equations 58 to 63 below can be derived.

$$u = {l}_{1}^{′} + r - {r}_{s 1} \qquad Equation 57 )$$

$${k}_{dFsv} = \frac{1}{\begin{matrix}\frac{1}{3} ( \frac{{u}^{2} ( 3 {l}_{1}^{′} - u )}{6 {EI}_{12}} - \frac{{a}_{1} {u}^{2}}{2 {EI}_{12}} + \frac{( {l}_{1}^{′} - {a}_{1} ) {l}_{2}^{′} u}{4 {GI}_{t}} + \\ \frac{{l}_{2}^{′3}}{192 {EI}_{22}} + \frac{4 {l}_{1}^{′} {S}_{2} + {l}_{2}^{′} {S}_{1}}{4 {kGS}_{1} {S}_{2}}\end{matrix}} \qquad Equation 58 )$$

$${k}_{dFyv} = \frac{1}{\begin{matrix}\frac{{B}_{3}}{2 {A}_{3} {A}_{4} cos ( π / 6 )} ( \frac{{u}^{2} ( 3 {l}_{1} - u )}{6 {EI}_{11}} - \\ \frac{{A}_{2} {u}^{2}}{2 {EI}_{11} B2} + \frac{{l}_{1}^{′} {l}_{2}^{′} u - {A}_{2} {l}_{2}^{′} / {B}_{2}}{15 {EI}_{21}} + \frac{u}{4 {kGS}_{1}} )\end{matrix}} \qquad Equation 59 )$$

$${k}_{dMxv} = \frac{1}{\begin{matrix}\frac{1}{3 ( r + \frac{1}{{a}_{2}} )} \frac{{u}^{2} ( 3 {l}_{1}^{′} - u )}{6 {EI}_{11}} - \frac{1}{3 ( {a}_{2} r + 1 )} \frac{{u}^{2}}{2 {EI}_{11}} + \\ ( \frac{1}{3 ( r + \frac{1}{{a}_{2}} )} {l}_{1}^{′} - \frac{1}{3 ( {a}_{2} r + 1 )} ) \frac{{ul}_{2}^{′}}{16 {EI}_{21}} + \\ \frac{1}{3 ( r + \frac{1}{{a}_{2}} )} \frac{{l}_{1}^{′}}{{kGS}_{1}}\end{matrix}} \qquad Equation 60 )$$

$${k}_{dMxv} = \frac{r}{\begin{matrix}\frac{1}{3 ( r + \frac{1}{{a}_{2}} )} \frac{{u}^{2} ( 3 {l}_{1}^{′} - u )}{6 {EI}_{11}} - \frac{1}{3 ( {a}_{2} r + 1 )} \frac{{u}^{2}}{2 {EI}_{11}} + \\ ( \frac{1}{3 ( r + \frac{1}{{a}_{2}} )} {l}_{1}^{′} - \frac{1}{3 ( {a}_{2} r + 1 )} ) \frac{{ul}_{2}^{′}}{16 {EI}_{21}} + \\ \frac{1}{3 ( r + \frac{1}{{a}_{2}} )} \frac{{l}_{1}^{′}}{{kGS}_{1}}\end{matrix}} \qquad Equation 61 )$$

$${k}_{dMxv} = \frac{1}{\begin{matrix}\frac{2}{3 ( \frac{{A}_{1}}{{B}_{1}} + r )} ( \frac{{l}_{2}^{′3}}{192 {EI}_{22}} + \frac{{l}_{2}^{′}}{4 {kGS}_{2}} + \frac{u}{{kGS}_{1}} + \\ \frac{{u}^{2} ( 3 {l}_{1}^{′} - u )}{6 {EI}_{12}} - \frac{{A}_{1}}{{B}_{1}} \frac{{u}^{2}}{2 {EI}_{12}} + \frac{( {l}_{1}^{′} - \frac{{A}_{1}}{{B}_{1}} ) {l}_{2}^{′} u}{4 {GI}_{t}} )\end{matrix}} \qquad Equation 62 )$$

$${k}_{dMxv} = \frac{r}{\begin{matrix}\frac{2}{3 ( \frac{{A}_{1}}{{B}_{1}} + r )} ( \frac{{l}_{2}^{′3}}{192 {EI}_{22}} + \frac{{l}_{2}^{′}}{4 {kGS}_{2}} + \frac{u}{{kGS}_{1}} + \\ \frac{{u}^{2} ( 3 {l}_{1}^{′} - u )}{6 {EI}_{12}} - \frac{{A}_{1}}{{B}_{1}} \frac{{u}^{2}}{2 {EI}_{12}} + \frac{( {l}_{1}^{′} - \frac{{A}_{1}}{{B}_{1}} ) {l}_{2}^{′} u}{4 {GI}_{t}} )\end{matrix}} \qquad Equation 63 )$$

In addition, K_{rMxh} may be derived by applying the position radius rₛ₂ of the horizontal displacement photocouplers (350, 360, 370) to the reciprocal of the x-axis-based torsional spring stiffness coefficient k_{Mx} of the spring structure (210) due to the x-axis-based rotational moment Mₓ of the external force, as defined by Equation 29.

In addition, K_{dFyh} may be derived by applying the position radius rₛ₂ of the horizontal displacement photocouplers (350, 360, 370) to the reciprocal of the y-axis linear spring stiffness coefficient k_{F}_{_{y}} of the spring structure (210) due to the y-axis component F_{y} of the external force, as defined by Equation 46.

In addition, K_{rMzh} may be derived by applying the position radius rₛ₂ of the horizontal displacement photocouplers (350, 360, 370) to the reciprocal of the z-axis-based torsional spring stiffness coefficient k_{M}_{_{z}} of the spring structure (210) due to the z-axis-based rotational moment M_{z} of the external force, as defined by Equation 55.

Specifically, by defining a radius variable u using the position radius rₛ₂ of the vertical displacement photocouplers (320, 330, 340) as in Equation 64 below, and applying the radius variable u to the reciprocals of Equations 18, 29, 46, and 55, Equations 65 to 70 below can be derived.

$$u = {l}_{1}^{′} + r - {r}_{s 2} \qquad Equation 64 )$$

$${k}_{dFzh} = \frac{1}{\begin{matrix}\frac{1}{3} ( \frac{{u}^{2} ( 3 {l}_{1}^{′} - u )}{6 {EI}_{21}} - \frac{{a}_{1} {u}^{2}}{2 {EI}_{12}} + \frac{( {l}_{1}^{′} - {a}_{1} ) {l}_{2}^{′} u}{4 {GI}_{t}} + \\ \frac{{l}_{2}^{′3}}{192 {EI}_{22}} + \frac{4 {l}_{1}^{′} {S}_{2} + {l}_{2}^{′} {S}_{1}}{4 {kGS}_{1} {S}_{2}}\end{matrix}} \qquad Equation 65 )$$

$${k}_{dFyh} = \frac{1}{\begin{matrix}\frac{{B}_{3}}{2 {A}_{3} {A}_{4} cos ( π / 6 )} ( \frac{{u}^{2} ( 3 {l}_{1} - u )}{6 {EI}_{11}} - \\ \frac{{A}_{2} {u}^{2}}{2 {EI}_{11} B2} + \frac{{l}_{1}^{′} {l}_{2}^{′} u - {A}_{2} {l}_{2}^{′} / {B}_{2}}{15 {EI}_{21}} + \frac{u}{4 {kGS}_{1}} )\end{matrix}} \qquad Equation 66 )$$

$${k}_{dMzh} = \frac{1}{\begin{matrix}\frac{1}{3 ( r + \frac{1}{{a}_{2}} )} \frac{{u}^{2} ( 3 {l}_{1}^{′} - u )}{6 {EI}_{11}} - \frac{1}{3 ( {a}_{2} r + 1 )} \frac{{u}^{2}}{2 {EI}_{11}} + \\ ( \frac{1}{3 ( r + \frac{1}{{a}_{2}} )} {l}_{1}^{′} - \frac{1}{3 ( {a}_{2} r + 1 )} ) \frac{{ul}_{2}^{′}}{16 {EI}_{21}} + \\ \frac{1}{3 ( r + \frac{1}{{a}_{2}} )} \frac{{l}_{1}^{′}}{{kGS}_{1}}\end{matrix}} \qquad Equation 67 )$$

$$k \text{?} = \frac{r}{\begin{matrix}\frac{1}{3 ( r + \frac{1}{{a}_{2}} )} \frac{{u}^{2} ( 3 {l}_{1}^{′} - u )}{6 {EI}_{11}} - \frac{1}{3 ( {a}_{2} r + 1 )} \frac{{u}^{2}}{2 {EI}_{11}} + \\ ( \frac{1}{3 ( r + \frac{1}{{a}_{2}} )} {l}_{1}^{′} - \frac{1}{3 ( {a}_{2} r + 1 )} ) \frac{{ul}_{2}^{′}}{16 {EI}_{21}} + \\ \frac{1}{3 ( r + \frac{1}{{a}_{2}} )} \frac{{l}_{1}^{′}}{{kGS}_{1}}\end{matrix}} \qquad Equation 68 )$$

$${k}_{dMxh} = \frac{1}{\begin{matrix}\frac{2}{3 ( \frac{{A}_{1}}{{B}_{1}} + r )} ( \frac{{l}_{2}^{′3}}{192 {EI}_{22}} + \frac{{l}_{2}^{′}}{4 {kGS}_{2}} + \frac{u}{{kGS}_{1}} + \\ \frac{{u}^{2} ( 3 {l}_{1}^{′} - u )}{6 {EI}_{12}} - \frac{{A}_{1}}{{B}_{1}} \frac{{u}^{2}}{2 {EI}_{12}} + \frac{( {l}_{1}^{′} - \frac{{A}_{1}}{{B}_{1}} ) {l}_{2}^{′} u}{4 {GI}_{t}} )\end{matrix}} \qquad Equation 69 )$$

$${k}_{dMxh} = \frac{r}{\begin{matrix}\frac{2}{3 ( \frac{{A}_{1}}{{B}_{1}} + r )} ( \frac{{l}_{2}^{′3}}{192 {EI}_{22}} + \frac{{l}_{2}^{′}}{4 {kGS}_{2}} + \frac{u}{{kGS}_{1}} + \\ \frac{{u}^{2} ( 3 {l}_{1}^{′} - u )}{6 {EI}_{12}} - \frac{{A}_{1}}{{B}_{1}} \frac{{u}^{2}}{2 {EI}_{12}} + \frac{( {l}_{1}^{′} - \frac{{A}_{1}}{{B}_{1}} ) {l}_{2}^{′} u}{4 {GI}_{t}} )\end{matrix}} \qquad Equation 70 )$$

$$\text{?} \text{indicates text missing or illegible when filed}$$

Meanwhile, through Equation 56, the calibration matrix G can be defined as in Equation 71 below.

$$A = Δ d / F = G \qquad Equation 71 )$$

Additionally, the Regulated Calibration Matrix G̅ can be defined as in Equation 72 below.

$$\overline{G} = {R}_{s}^{- 1} G \qquad Equation 72 )$$

Here, R_{S} is a Sensitivity Regulation Matrix that corrects the sensitivity of each axis and can be derived based on the displacement of each axis measured by the photocouplers (320, 330, 340, 350, 360, 370). For example, a sensitivity regulation matrix R_{S} can be derived as in Equation 73 below.

$${R}_{2} = R * 1 / diag [ 2.4 2.4 111 2.4 ] \qquad Equation 73 )$$

Here, R is a Regulation Matrix, which can be derived as in Equation 74 below.

R=diag[100%/Fx_max 100%/Fy_max 100%/Fz_max, Equation 74) 100%/Mx_max 100%/My_max 100%/Mz_max]

In addition, by maximizing the regulated calibration matrix G̅ and minimizing the Condition Number Con(G̅) of the regulated calibration matrix G̅, thereby minimizing the value Con(G̅)/|G̅|, a 6-axis force-torque sensing apparatus having high sensitivity and stability can be provided.

In addition, the design of the spring structure (210) as described above must satisfy the constraints of Equations 75 to 79 below.

$$- {l}_{1} + 3 {b}_{1} < 0 \qquad Equation 75 )$$

$$- {l}_{1} + 3 h < 0 \qquad Equation 76 )$$

$$\sqrt{{( r + {l}_{1} + {b}_{2} )}^{2} + {( {l}_{2} / 2 )}^{2}} < 0.02 \qquad Equation 77 )$$

$$- {σ}_{allowable} + {σ}_{bend} < 0 \qquad Equation 78 )$$

$$- {σ}_{allowable} + {σ}_{torsion} < 0 \qquad Equation 79 )$$

Here, Equations 75 to 76 are conditions for calculating an accurate spring constant, and Equation 77 is a structural dimensional constraint of the spring structure (210). For example, the parameters can be set as 1 mm≤l₁≤20 mm, 11 mm≤l₂≤30 mm, 1 mm≤b₁≤10 mm, 0.5 mm≤b₂≤1 mm, 1 mm≤h≤15 mm, 1 mm≤r≤8 mm, 2 mm≤rₛ₂≤15 mm. Specifically, l₁ may be set to 14.24 mm, l₂ to 11.00, b₁ to 3.039 mm, b₂ to 0.5535 mm, h to 6.690 mm, r to 4.437 mm, and rₛ₂ to 8.800 mm. Also, as another example, l₁ may be set to 14.03 mm, l₂ to 14.50, b₁ to 3.00 mm, b₂ to 0.60 mm, h to 6.00 mm, and r to 4.00 mm.

In addition, Equations 78 and 79 are allowable external force limit conditions that the spring structure (210) can withstand. Here, σ_{allowable} is the maximum allowable stress of the spring structure (210), σ_{bend} is the bending stress caused by the force or rotational torque acting on the spring structure (210), and σₜₒᵣₛᵢₒₙ is the torsional stress caused by the force or rotational torque acting on the spring structure (210).

Table 2 shows the results of comparing the force-torque measurement ranges of a 6-axis force-torque sensing apparatus (1) according to one embodiment of the present disclosure and a commercial 6-axis force-torque sensing apparatus, RFT40, according to the prior art.

TABLE 2

| | Measurement range of the 6- | |
|---|---|---|
| | axis force-torque apparatus (1) | Measurement range of |
| Force/Moment | of the present disclosure | RFT40 |
| Fₓ | −620 N~+620 N | −100 N~+100 N |
| F_{y} | −590 N~+590 N | −100 N~+100 N |
| F_{z} | −1650 N~+1650 N | −150 N~+150 N |
| Mₓ | −13.7 N · m~+13.7N · m | −2.5 N · m~+2.5 N · m |
| M_{y} | −13.6 N · m~+13.6 N · m | −2.5 N · m~+2.5 N · m |
| M_{z} | −19.6 N · m~+19.6 N · m | −2.5 N · m~+2.5 N · m |

Referring to Table 2, it can be confirmed that the 6-axis force-torque sensing apparatus (1) according to the present disclosure has a wider measurement range compared to the RFT40, which is a commercial 6-axis force-torque sensing apparatus according to the prior art. In addition, the 6-axis force-torque sensing apparatus (1) designed as described above can be manufactured in a miniaturized size, leading to high utility, and can minimize weight when manufactured with lightweight metal. For example, the 6-axis force-torque sensing apparatus (1) according to the present disclosure can be manufactured using AL7075-T6 as a material, and can be manufactured as a small, lightweight apparatus with a diameter of 40 mm, a height of 17.47 mm, and a weight of 38 g.

In addition, FIG. 14 shows experimental results comparing the force-torque measurement results of the 6-axis force-torque sensing apparatus (1) according to the present disclosure and the ATI-MINI85, a commercial 6-axis force-torque sensing apparatus according to the prior art.

Here, the force-torque measurement result of the 6-axis force-torque sensing apparatus (1) according to the present disclosure is shown as a graph in the form of a thick dotted line, and the force-torque measurement result of ATI-MINI85 is shown as a graph in the form of a thin solid line.

In addition, Table 3 shows the physical characteristics of the 6-axis force-torque sensing apparatus (1) according to the present disclosure applied to the experiment from which the graph of FIG. 14 was derived.

TABLE 3

| | Value | Unit |
|---|---|---|
| Input Force Range X | ±1,050 | N |
| Input Force Range Y | ±1,200 | N |
| Input Force Range Z | ±1,850 | N |
| Input Moment Range X, Y | ±25 | N · m |
| Input Moment Range Z | ±36 | N · m |
| Resonance Frequency X | 12006 | N · m |
| Resonance Frequency Y | 12039 | Hz |
| Resonance Frequency Z | 14154 | Hz |
| Sampling Frequency | 5 | Hz |

In addition, Table 4 shows the results of Error Analysis for evaluating the force-torque sensing performance of the 6-axis force-torque sensing apparatus (1) according to the present disclosure applied to the experiment from which the graph of FIG. 14 was derived, and Table 5 shows the results of Nonlinearity and Hysteresis analysis using the data of Table 4.

TABLE 4

| | Percentage Error (%) | | | RMS |
|---|---|---|---|---|
| | Mean | Std | Max | Error(N, N · m) |
| Fₓ | 0.0460 | 0.0742 | 0.3600 | 0.5703 |
| F_{y} | −0.0343 | 0.0706 | 0.3008 | 2.25 |
| F_{z} | 0.0172 | 0.0416 | 0.1316 | 0.6757 |
| Mₓ | 0.0627 | 0.2669 | 0.8802 | 0.0172 |
| M_{y} | 0.0570 | 0.2410 | 0.8672 | 0.0155 |
| M_{z} | 0.0161 | 0.0852 | 0.3879 | 0.0063 |

TABLE 5

| | Nonlinearity and Hysteresis |
|---|---|
| Fₓ | 0.607% |
| F_{y} | 0.521% |
| F_{z} | 0.240% |
| Mₓ | 1.543% |
| M_{y} | 1.699% |
| M_{z} | 0.681% |

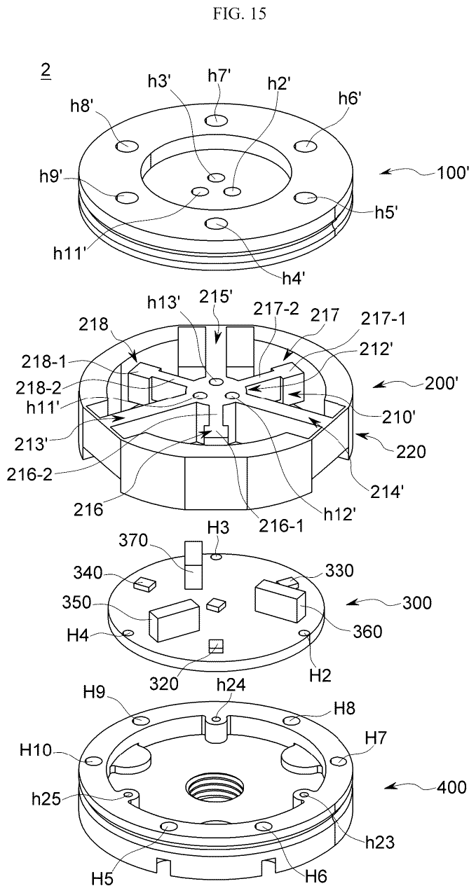

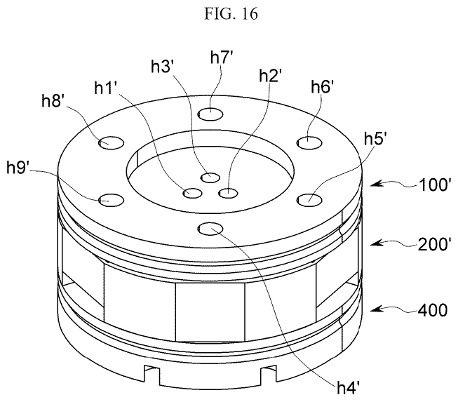

Referring to FIG. 14 and Tables 3 to 5, it can be confirmed that the 6-axis force-torque sensing apparatus (1) according to the present disclosure has a lower error rate and is more stable compared to the ATI-MINI85. In addition, the maximum value of nonlinearity is 1.699%, which is lower than the 3.0% standard for existing commercial sensors, confirming that it is a sensor with excellent accuracy and reliability, suitable for high-precision measurements. Hereinafter, a force-torque sensing apparatus (2) according to a second embodiment of the present disclosure will be described with reference to FIGS. 15 and 16.

FIG. 15 is an exploded perspective view of a 6-axis force-torque sensing apparatus (2) according to a second embodiment of the present disclosure, viewed from above, and FIG. 16 is a perspective view of the 6-axis force-torque sensing apparatus (2) with the components shown in FIG. 15 assembled.

A 6-axis force-torque sensing apparatus (2) according to the second embodiment follows the 6-axis force-torque sensing apparatus (1) according to the first embodiment but differs from the first embodiment in that the spring structure (210′) of the deformable structure (200′) includes spring protrusions (216, 217, 218) that serve as vertical displacement portions, and the cover (100′) is disposed on the upper side of the frame structure (220).

Referring to FIG. 15, the spring protrusions (216, 217, 218) are configured to extend radially in a horizontal direction from the central portion (212′), and the spring structure (210′) can be provided in a configuration in which at least three beam portions (213′, 214′, 215′) and at least three spring protrusions (216, 217, 218) are alternately arranged at regular intervals around the central portion (212′).

For example, the spring structure (210′) may be configured with three beam portions (213′, 214′, 215′) and three spring protrusions (216, 217, 218) arranged alternately at 60-degree intervals centered on the central portion (212′).

In addition, the spring protrusions (216, 217, 218) may be configured to include linear extension portions (216-2, 217-2, 218-2) extending from the central portion (212′) with a predetermined width and thickness, and vertical displacement portions (216-1, 217-1, 218-1) formed at the ends of the extension portions (216-2, 217-2, 218-2). Here, the vertical displacement portions (216-1, 217-1, 218-1) can be designed to be wider and thicker than the extension portions (216-2, 217-2, 218-2).

In this case, vertical displacement photocouplers (320, 330, 340) may be disposed below the vertical displacement portions (216-1, 217-1, 218-1) on the substrate (310). Specifically, the light-emitting element (321, 331, 341) and the light-receiving element (322, 332, 342) of each vertical displacement photocoupler (320, 330, 340) can be arranged parallel to the bottom surface of each vertical displacement portion (216-1, 217-1, 218-1). In addition, the vertical reference gap between the vertical displacement portions (216-1, 217-1, 218-1) and the vertical displacement photocouplers (320, 330, 340) can be designed to have a constant, predetermined value. Accordingly, by analyzing the light emitted from the light-emitting element (321, 331, 341) of the vertical displacement photocoupler (320, 330, 340), reflected from the bottom surface of the vertical displacement portion (216-1, 217-1, 218-1), and then collected by the light-receiving element (322, 332, 342) of the vertical displacement photocoupler (320, 330, 340), the vertical displacement of the vertical displacement portions (216-1, 217-1, 218-1) can be measured.

Additionally, in this case, the beam portions (213′, 214′, 215′) serve as horizontal displacement portions, and horizontal displacement photocouplers (350, 360, 370) can be disposed horizontally outward of the beam portions (213′, 214′, 215′). Specifically, the light-emitting element (351, 361, 371) and the light-receiving element (352, 362, 372) of each horizontal displacement photocoupler (350, 360, 370) can be arranged parallel to the side surface of each beam portion (213′, 214′, 215′). Here, the side surface refers to a surface that is arranged in a vertical direction. Accordingly, by analyzing the light emitted from the light-emitting element (351, 361, 371) of the horizontal displacement photocoupler (350, 360, 370), reflected from the side surface (B′) of the beam portion (213′, 214′, 215′), and then collected by the light-receiving element (352, 362, 372) of the horizontal displacement photocoupler (350, 360, 370), the horizontal displacement of the beam portion (213′, 214′, 215′) can be measured.

Additionally, in this case, the vertical length of the beam portions (213′, 214′, 215′) can be designed to be longer than the vertical deformation range of the spring structure (210′) due to external force.

In addition, referring to FIGS. 15 and 16, the cover (100′) is disposed on the upper side of the frame structure (220) and is designed so that a predetermined gap exists between the top of the frame structure (220) and the bottom of the cover (100′), so that the cover (100′) can be configured to move vertically or in an inclined direction by an external force.

Here, vertical deformable structure coupling screw holes (h1′, h2′, h3′) for screw coupling of the cover (100′) and the spring structure (210) may be formed in the central portion (101) of the cover (100′), and vertical external force apparatus coupling screw holes (h4′, h5′, h6′, h7′, h8′, h9′) for screw coupling with an external force apparatus may be formed in the edge portion (102). In addition, the deformable structure coupling screw holes (h1′, h2′, h3′) can be formed at 120-degree intervals with a constant gap, and the external force apparatus coupling screw holes (h4′, h5′, h6′, h7′, h8′, h9′) can be formed at 60-degree intervals with a constant gap.

In addition, vertical cover coupling screw holes (h11′, h12′, h13′) for screw coupling with the cover (100′) may be formed in the central portion (212′) of the spring structure (210′). In addition, the cover coupling screw holes (h11′, h12′, h13′) may be formed in the same number as and at positions corresponding to the deformable structure coupling screw holes (h1′, h2′, h3′) of the cover (100′), and screws may be fastened into each pair of corresponding screw holes to couple the cover (100′) and the spring structure (210′).

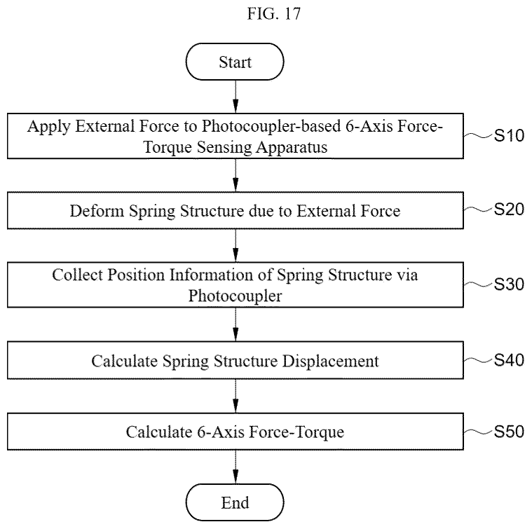

Hereinafter, a photocoupler-based 6-axis force-torque sensing method using a 6-axis force-torque sensing apparatus (1) according to the first embodiment of the present disclosure will be described with reference to FIG. 17. In addition, even when using the 6-axis force-torque sensing apparatus (2) according to the second embodiment, the same 6-axis force-torque sensing method as the 6-axis force-torque sensing method using the 6-axis force-torque sensing apparatus (1) according to the first embodiment is applied.

Step S10 is a step in which an external force is applied to a photocoupler-based 6-axis force-torque sensing apparatus (1) according to the present disclosure and the external force is transmitted to a deformable structure (200).

Step S20 is a step in which the spring structure (210) of the deformable structure (200) is deformed by an external force and its position changes.

Step S30 is a step in which position information of the spring structure (210) is collected as light emitted from light-emitting elements (321, 331, 341, 351, 361, 371) of at least 6 photocouplers (320, 330, 340, 350, 360, 370) arranged at different positions is reflected by the spring structure (210) and then collected by the light-receiving elements (322, 332, 342, 352, 362, 372).

Step S40 is a step of calculating the displacement of the spring structure (210) using the position information of the spring structure (210) respectively sensed through the photocouplers (320, 330, 340, 350, 360, 370) in the data processing unit (393).

Step S50 is a step of calculating a 6-axis force-torque by calculating the magnitude and direction of an external force applied to the spring structure (210) using the displacement of the spring structure (210) in the data processing unit (393).

As described above, according to the 6-axis force-torque sensing apparatus and 6-axis force-torque sensing method of the present disclosure, the magnitude and direction of an external force can be measured in a non-contact manner using photocouplers (320, 330, 340, 350, 360, 370). Therefore, a 6-axis force-torque sensing apparatus and a 6-axis force-torque sensing method having improved durability against impact and thus improved stability and reliability can be provided.

In addition, by providing a method for measuring the magnitude and direction of an external force using a photocoupler, the influence of external static electricity and electromagnetic fields can be minimized.

In addition, by integrating the reflector of the photocoupler and the spring structure into a single structure, the number of components can be reduced, and the sensor structure can be simplified into two structures—an upper structure to which force is transmitted and a lower structure that measures the force—thereby reducing manufacturing costs and providing a more compact 6-axis force-torque sensing apparatus.

The foregoing description of the present disclosure is for illustrative purposes only, and one of ordinary skill in the art to which the present disclosure pertains will understand that it can be easily modified into other specific forms without changing the technical spirit or essential characteristics thereof. Therefore, it should be understood that the embodiments described above are exemplary in all respects and not limiting. For example, each component described as a single entity may be implemented in a distributed manner, and likewise, components described as distributed may be implemented in a combined form.

Therefore, the spirit of the present disclosure should not be limited to the embodiments described above, and all modifications that are equivalent or equivalently transformed from the following claims, as well as the claims themselves, shall be considered to fall within the scope of the spirit of the present disclosure.

### DESCRIPTION OF THE SYMBOLS

1: 6-axis force-torque sensing apparatus according to the first embodiment
100: Cover
200: Deformable structure
210: Spring structure
213, 214, 215: Beam portion
213-1, 214-1, 215-1: Vertical displacement portion
213-2, 214-2, 215-2: Horizontal displacement portion
220: Frame structure
300: Sensing substrate
310: Substrate
320, 330, 340: Vertical Displacement Photocoupler
350, 360, 370: Horizontal Displacement Photocoupler
391: Communication Unit
393: Data Processing Unit
394: Temperature Sensor
395: Voltage Regulator
396: Data Processing Unit Debugger
397: CAN/PW Connector
400: Sensing Substrate Support

What is claimed is:

1. A photocoupler-based 6-axis force-torque sensing apparatus, comprising:
a deformable structure comprising a spring structure including a vertical displacement portion and a horizontal displacement portion and configured to elastically deform in response to an external force, and a frame structure configured to support the spring structure;
a sensing substrate comprising a vertical displacement photocoupler disposed below the vertical displacement portion and configured to sense a vertical displacement of the vertical displacement portion, and a horizontal displacement photocoupler disposed horizontally outward of the horizontal displacement portion and configured to sense a horizontal displacement of the horizontal displacement portion; and
a sensing substrate support configured to support the sensing substrate and coupled to the frame structure such that a gap of a predetermined range is formed between the spring structure and the sensing substrate.

2. The photocoupler-based 6-axis force-torque sensing apparatus of claim 1, wherein
the spring structure includes at least three beam portions arranged at regular intervals extending radially in a horizontal direction from a central portion and connected to the frame structure,
the vertical displacement portion is a portion connected from the central portion to the frame structure in each beam portion,
the horizontal displacement portion is a portion extending vertically downward from one widthwise end of the vertical displacement portion in each beam portion.

3. The photocoupler-based 6-axis force-torque sensing apparatus of claim 1, wherein
the spring structure includes at least three beam portions extending radially in a horizontal direction from a central portion and connected to the frame structure, and at least three spring protrusions extending radially in a horizontal direction from the central portion,
the vertical displacement portions are the respective beam portions, and
the horizontal displacement portion is formed at the end of a linear extension portion extending radially in a horizontal direction from the central portion of each spring protrusion.

4. The photocoupler-based 6-axis force-torque sensing apparatus of claim 1, wherein
the vertical displacement photocoupler and the horizontal displacement photocoupler each include a light-emitting element that emits light and a light-receiving element that senses light and converts it into an electrical signal according to the intensity,
the light emitted from the light-emitting element of the vertical displacement photocoupler is reflected on a bottom surface of the vertical displacement portion and then collected by the light-receiving element of the vertical displacement photocoupler, thereby sensing a change in the gap between the vertical displacement photocoupler and the bottom surface of the vertical displacement portion, and
the light emitted from the light-emitting element of the horizontal displacement photocoupler is reflected on a horizontally outward surface of the horizontal displacement portion and then collected by the light-receiving element of the horizontal displacement photocoupler, thereby sensing a change in the gap between the horizontal displacement photocoupler and the horizontally outward surface of the horizontal displacement portion.

5. The photocoupler-based 6-axis force-torque sensing apparatus of claim 4, wherein
the sensing substrate further comprises a data processing unit that receives an electrical signal corresponding to the intensity of light collected through the light-receiving elements of the vertical displacement photocoupler and the horizontal displacement photocoupler, and calculates the displacement of the spring structure based thereon.

6. The photocoupler-based 6-axis force-torque sensing apparatus of claim 4, wherein
the light-emitting element and the light-receiving element of the vertical displacement photocoupler are arranged parallel to the bottom surface of the vertical displacement portion at a predetermined distance, and
the light-emitting element and the light-receiving element of the horizontal displacement photocoupler are arranged parallel to the outward surface of the horizontal displacement portion at a predetermined distance.

7. The photocoupler-based 6-axis force-torque sensing apparatus of claim 1,
further comprising a cover coupled to an upper side of the spring structure and coupled to an external force apparatus above it to transmit an external force from the external force apparatus to the spring structure.

8. The photocoupler-based 6-axis force-torque sensing apparatus of claim 2, wherein
the spring structure includes a first beam portion, a second beam portion, and a third beam portion arranged at 120-degree intervals,
the first beam portion includes a first vertical displacement portion and a first horizontal displacement portion, the second beam portion includes a second vertical displacement portion and a second horizontal displacement portion, and the third beam portion includes a third vertical displacement portion and a third horizontal displacement portion, and
the sensing substrate comprises a first vertical displacement photocoupler for measuring displacement of the first vertical displacement portion, a first horizontal displacement photocoupler for measuring displacement of the first horizontal displacement portion, a second vertical displacement photocoupler for measuring displacement of the second vertical displacement portion, a second horizontal displacement photocoupler for measuring displacement of the second horizontal displacement portion, a third vertical displacement photocoupler for measuring displacement of the third vertical displacement portion, and a third horizontal displacement photocoupler for measuring displacement of the third horizontal displacement portion, disposed at positions corresponding respectively to the first vertical displacement portion, the first horizontal displacement portion, the second vertical displacement portion, the second horizontal displacement portion, the third vertical displacement portion, and the third horizontal displacement portion.

9. The photocoupler-based 6-axis force-torque sensing apparatus of claim 8, wherein
a longitudinal direction of the first beam portion is set as an x-axis, a direction orthogonal to the x-axis in a plane between the first beam portion and the second beam portion is set as a y-axis, and an upward direction of the spring structure, which is orthogonal to the x-axis and the y-axis, is set as a z-axis,
an x-axis component Fₓ, a y-axis component F_{y}, and a z-axis component F_{z} of an external force, and an x-axis-based rotational moment Mₓ and a y-axis-based rotational moment M_{y} generated by the external force are measured through the first vertical displacement portion, the first horizontal displacement portion, the second vertical displacement portion, the second horizontal displacement portion, the third vertical displacement portion, and the third horizontal displacement portion,
a displacement Δd₁ of the first vertical displacement portion, a displacement Δd₂ of the first horizontal displacement portion, a displacement Δd₃ of the second vertical displacement portion, a displacement Δd₄ of the second horizontal displacement portion, a displacement Δd₅ of the third vertical displacement portion, and a displacement Δd₆ of the third horizontal displacement portion are calculated according to Equations 1 to 6 below, respectively, and
$$Δ {d}_{1} = - {F}_{z} / {k}_{dFzv} - {M}_{x} {r}_{x 1} / {k}_{rMxv} \qquad Equation 1 )$$
$$Δ {d}_{2} = - {F}_{z} / {k}_{dFzv} - {M}_{x} {r}_{s 1} sin ( π / 3 ) / {k}_{rMxv} + {M}_{y} {r}_{s 1} sin ( π / 6 ) / {k}_{rMxv} \qquad Equation 2 )$$
$$Δ {d}_{3} = - {F}_{z} / {k}_{dFzv} + {M}_{x} {r}_{s 1} sin ( π / 3 ) / {k}_{rMxv} + {M}_{y} {r}_{s 1} sin ( π / 6 ) / {k}_{rMxv} \qquad Equation 3 )$$
$$Δ {d}_{4} = {F}_{y} / {k}_{dFyh} + {M}_{x} ( h / 2 - c ) / {k}_{rMxh} + {M}_{z} / {k}_{dMzh} \qquad Equation 4 )$$
$$Δ {d}_{5} = - {F}_{x} sin ( π / 3 ) / {k}_{dFyh} - {F}_{y} sin ( π / 6 ) / {k}_{dFyh} - {M}_{x} ( h / 2 - c ) sin ( π / 6 ) / {k}_{rMxh} - {M}_{y} ( h / 2 - c ) sin ( π / 3 ) / {k}_{rMxh} + {M}_{z} / {k}_{dMzh} \qquad Equation 5 )$$
$$Δ {d}_{6} = {F}_{x} sin ( π / 3 ) / {k}_{dFyh} - {F}_{y} sin ( π / 6 ) / {k}_{dFyh} + {M}_{x} ( h / 2 - c ) sin ( π / 6 ) / {k}_{rMxh} + {M}_{y} ( h / 2 - c ) sin ( π / 3 ) / {k}_{rMxh} + {M}_{z} / {k}_{dMzh} \qquad Equation 6 )$$
a relationship between the displacement Δd₁ of the first vertical displacement portion, the displacement Δd₂ of the second vertical displacement portion, the displacement Δd₃ of the third vertical displacement portion, the displacement Δd₄ of the first horizontal displacement portion, the displacement Δd₅ of the second horizontal displacement portion, and the displacement Δd₆ of the third horizontal displacement portion, the x-axis component Fₓ, the y-axis component F_{y}, the z-axis component F_{z} of the external force, the x-axis-based rotational moment Mₓ, the y-axis-based rotational moment M_{y}, a z-axis-based rotational moment M_{z} generated by the external force is defined as in Equation 7 below,
$$Δ d = AF , \qquad Equation 7 )$$
$$A = [ \begin{matrix}0 & 0 & - \frac{1}{{k}_{dFzv}} & 0 & - \frac{{r}_{s 1}}{{k}_{rMxv}} & 0 \\ 0 & 0 & - \frac{1}{{k}_{dFzv}} & - \frac{{r}_{s 1} sin ( π / 3 )}{{k}_{rMxv}} & \frac{{r}_{s 1} sin ( π / 6 )}{{k}_{rMxv}} & 0 \\ 0 & 0 & - \frac{1}{{k}_{dFzv}} & \frac{{r}_{s 1} sin ( π / 3 )}{{k}_{rMxv}} & \frac{{r}_{s 1} sin ( π / 6 )}{{k}_{rMxv}} & 0 \\ 0 & \frac{1}{{k}_{dFyh}} & 0 & \frac{( h / 2 - c )}{{k}_{rMxh}} & 0 & \frac{1}{{k}_{dMzh}} \\ \frac{- sin ( π / 3 )}{{k}_{dFyh}} & \frac{- sin ( π / 6 )}{{k}_{dFyh}} & 0 & \frac{- ( h / 2 - c ) sin ( π / 6 )}{{k}_{rMxh}} & \frac{- ( h / 2 - c ) sin ( π / 3 )}{{k}_{rMxh}} & \frac{1}{{k}_{dMzh}} \\ \frac{sin ( π / 3 )}{{k}_{dFyh}} & \frac{- sin ( π / 6 )}{{k}_{dFyh}} & 0 & \frac{( h / 2 - c ) sin ( π / 6 )}{{k}_{rMxh}} & \frac{( h / 2 - c ) sin ( π / 3 )}{{k}_{rMxh}} & \frac{1}{{k}_{dMzh}}\end{matrix} ] ,$$
$$Δ d = [ \begin{matrix}Δ {d}_{1} \\ Δ {d}_{2} \\ Δ {d}_{3} \\ Δ {d}_{4} \\ Δ {d}_{5} \\ Δ {d}_{6}\end{matrix} ] , F = [ \begin{matrix}{F}_{x} \\ {F}_{y} \\ {F}_{z} \\ {M}_{x} \\ {M}_{y} \\ {M}_{z}\end{matrix} ]$$
wherein rₛ₁ is a position radius of the vertical displacement photocoupler, k_{rMxv} is a torsional spring constant of the vertical displacement portion due to x-axis and y-axis rotational moments at the point rₛ₁, and K_{dFzv} is a spring constant corresponding to z-axis deformation of the vertical displacement portion at the point rₛ₁,
rₛ₂ is a position radius of the horizontal displacement photocoupler, K_{rMxh} is a spring constant corresponding to deformation of the horizontal displacement portion due to x-axis and y-axis rotational moments at the point rₛ₂, K_{dFyh} is a spring constant corresponding to deformation of the horizontal displacement portion caused by a force in a y-axis direction at the point rₛ₂, and K_{rMzh} is a spring constant corresponding to deformation of the horizontal displacement portion caused by a z-axis rotational moment at the point rₛ₂,
h is a vertical thickness of the spring structure, and c is a vertical distance from a substrate of the sensing substrate
to the horizontal displacement photocoupler.

10. The photocoupler-based 6-axis force-torque sensing apparatus of claim 9, wherein
a calibration matrix G is calculated according to Equation 8 below, and
$$A = Δ d / F = G \qquad Equation 8 )$$
a regulated calibration matrix G̅ is defined according to Equation 9 below.
$$\overline{G} = {R}_{s}^{- 1} G \qquad Equation 9 )$$

11. A photocoupler-based 6-axis force-torque sensing apparatus, comprising:
applying an external force to a spring structure configured to elastically deform in response to the external force, thereby causing deformation;
sensing a vertical displacement of a vertical displacement portion of the spring structure via a vertical displacement photocoupler disposed below the vertical displacement portion, and sensing a horizontal displacement of a horizontal displacement portion of the spring structure via a horizontal displacement photocoupler disposed horizontally outward of the horizontal displacement portion;
receiving, at a data processing unit, an electrical signal corresponding to an intensity of light collected by a light-receiving element of the vertical displacement photocoupler and by a light-receiving element of the horizontal displacement photocoupler, and calculating a displacement of the spring structure based thereon; and
calculating, at the data processing unit, a magnitude and direction of the external force applied to the spring structure using the displacement of the spring structure.
